(19) United States
(12) Patent Application Publication
(10) Pub. No.: US 2013/0043725 A1
(43) Pub. Date: Feb. 21, 2013

(54) Method and Apparatus for Managing Transmission of Power in a Power Transmission Network

(71) Applicant: Mogen Birkelund, Hojslev (DK)

(72) Inventor: Mogen Birkelund, Hojslev (DK)

(21) Appl. No.: 13/388,281

(22) PCT Filed: Aug. 2, 2010
(86) PCT No.: PCT/DK10/00114

§ 371 Date: Mar. 8, 2012

(30) Foreign Application Priority Data
Jul. 31, 2009 (DK) PCTDK/2009000179

(51) Int. Cl. H02J 3/38

(52) U.S. Cl. 307/24

(57) ABSTRACT

The invention relates to a method of managing transmission of power in a power transmission network, said method comprising the steps of: establishing utility grid characteristic comprising at least one reference value based on at least one parameter reflecting the state of said transformer, continuously monitoring said at least one parameter reflecting the state of said transformer, and continuously controlling power consumption and/or power production at the lower voltage side of said transformer based on said monitoring of said at least one parameter reflecting the state of said transformer, said controlling of said power consumption and/or said power production comprising regulating said power consumption of one or more of said plurality of power consumers and/or regulating said power production of one or more decentralized power producers located at said lower voltage side of said transformer, so as to comply with said established reference value.

### BACKGROUND OF THE INVENTION

The need of electrical power is growing, and there is an increased focus on producing more electrical power by means of renewable energy to spare the environment. This among other things increases the demand to the utility grid since more electric power producers are connected to the utility grid at different locations in the utility grid to comply with the growing need for power and demands for green energy/renewable energy.

On of the problems related to the consumer grid is that the production of energy at some point will have to match the consumption. This may lead to expensive over production of energy due to the fact that it is generally unacceptable that the power production is too low at any time.

This may even lead to that power producers will have to pay power producers, e.g. in other countries or states, in order to get rid of the over production. Moreover, this process involves that the grid will have to support this non-productive transport of energy.

One way of addressing this problem is to control the energy consumption of the consumers e.g. by positioning specialised remote-controlled equipment at the premises of the consumers in order to modify the consumption.

An alternative way of addressing this problem is to establish a prediction which makes it possible to control the power plants efficiently.

### THE INVENTION

The invention relates to a method of managing transmission of power in a power transmission network by means of a control arrangement, said power transmission network comprising:
a utility grid comprising transmission lines, distribution lines and one or more substations, one of said substations being a transformer having a high voltage side and a low voltage side, said transformer being adapted to transform power from a high voltage level to a low voltage level,
at least one central power producer being adapted to produce power, said power being transformed by said transformer from said high voltage level to said low voltage level,
a plurality of power consumers being adapted to consume said power produced by said at least one central power producer when said power is transformed by said transformer,
a data communication network connected to said one or more substations, said at least one central power producer, said plurality of power consumers and said control arrangement,
   said method comprising the steps of:
establishing utility grid characteristic comprising at least one reference value based on at least one parameter reflecting the state of said transformer,
continuously monitoring said at least one parameter reflecting the state of said transformer, and
continuously controlling power consumption and/or power production at said low voltage side of said transformer based on said monitoring of said at least one parameter reflecting the state of said transformer,
said controlling of said power consumption and/or said power production comprising regulating said power consumption of one or more of said plurality of power consumers and/or regulating power production of one or more power producers located at said low voltage side of said transformer, so as to comply with said established reference value.

It is understood that the above mentioned continuous monitoring of the parameter may be performed with a predefined time interval e.g. every minute, every five minutes, every 30 minutes, every hour, every two hour etc. Likewise, the continuous monitoring may be performed with a varying time interval, on request of an operator of the system, in real time or at any other appropriate time to facilitate adequate monitoring of the parameter.

It is furthermore understood that the above mentioned power producer at the low voltage side of the transformer from time to time may be referred to as a decentralized power producer.

It is understood that for the purpose of this document, the term transformer is to be understood as a device that transfers electrical energy from one circuit to another preferably through inductively coupled conductors which are coils of the transformer. A varying current in the first winding, also called the primary windings, creates a varying magnetic flux in the transformer, and thus a varying magnetic field through the secondary windings of the transformer. This varying magnetic field induces a “voltage” in the secondary winding. If a load (i.e. a power consumer) is connected to the secondary windings, an electric current will flow in the secondary winding and electrical energy will be transferred from the primary circuit through the transformer to the load.

It is understood that the established reference value(s) preferably is/are correlated with said monitoring of said parameter(s) so as to determine if the monitored parameter(s) comply with the established reference value(s).

The lower voltage side of the transformer, i.e. the side of the transformer with the lower voltage level which in power transmission network often is referred to as the secondary side of the transformer may according to the invention be connected to power consumers or power consumers together with decentralized power producers/plants. An example of the amount of electrical energy produced by a larger decentralized power plant/producer may e.g. be between 1-2 MW up to e.g. 100-150 MW. Most common energy sources of such larger decentralized power plants are natural gas, solar power, larger wind power arrangements such as wind turbines in the 1-10 MW range, larger generators driven by fossil fuel, hydro electric power (e.g. produced by wave energy) etc. Also smaller and/or larger wind parks with a plurality of wind turbines may be considered as a decentralized power plant. Common to such larger decentralized power plants is that they are often connected to the distribution lines of the utility grid at a voltage level between a consumer voltage level and the high voltage levels of the transmission lines, e.g. at a voltage level between 20 kV and 80 kV.

Decentralized power plants may also be smaller decentralized power plants which may comprise smaller wind turbines, local power generators driven by e.g. fossil fuel and/or CO2 neutral fuel, local solar cell arrangements, biogas plants, fitness centers with fitness equipment coupled to the grid and generating power when utilized by a person, power generation by means of e.g. slurry etc. Such smaller decentralized power plants may be arranged at a consumer voltage level generating and distributing power at a voltage directly consumable by a consumer without further step-down transformation of the voltage. A decentralized power producer may also be a mobile power producer which may be coupled to the utility grid at the distribution lines at various locations, preferably at a consumer voltage level.

In general, transformers are often a vital part of the utility grid. Furthermore, a transformer is a cost expensive and time consuming part of the grid to exchange or repair in case of breakdown. By monitoring one or more parameters of the transformer during a period of time and performing a regulation of the power at the lower voltage side of the transformer based on one or more reference values, a protection of the transformer is achieved, thus significantly reducing the risk of disadvantageous loads on the transformer.

When referring to the state of the transformer interfacing the transmission line with the distribution line having the lower voltage level, it should be noted that the term “state” may refer to e.g. one or more continuously measured data, where the data advantageously may refer to the present performance of the transformer. This performance may be measured directly on/in the transformer or it may be determined implicitly when measuring in other parts of the utility grid, as long as the measuring in the other part of the grid to at least a certain degree may be correlated to the performance of transformer. In this context, it should be noted that the performance of the transformer also may refer to certain thresholds, values and/or representations, which, when determined are considered to refer to at “safe-mode” of the transformer. In other words, measured representations determining that the transformer is overloaded, malfunctioning or close to malfunctioning may be applied. However, it would also be possible, within the scope of the invention, to monitor certain parameters or representations in the transformer or remote to the transformer and simply perform the intended controlling of power according to the assumption that it considered safe as long as the measured values are within certain limit(s).

In other words, it is possible measure parameters and apply these for the intended power control by assuming that certain monitored values reflect the intended operation of the transformer and/or by determining that something is actually happening in a non-intended way.

Furthermore, it should be noted that a reference value or reference values broadly refer to, of course, numerical values as such but also more complex representations. However, complex representation may also e.g. refer to multi-dimensional representations, statistical representations. This is in particular relevant, when a single or a few number of reference values are insufficient as a reference for the intended power control.

Hence, it would also be possible to apply statistical, fuzzy or neural inspired control.

Furthermore, a more stabile and predictable utility grid may be achieved in that the utility grid can be controlled at least partly locally at the secondary side of a transformer to comply with the reference value.

The above mentioned utility grid characteristic may comprise parameters as mentioned above and an example of such parameters may e.g. be current, voltage, power, cost of power, power factor, temperatures, time the transformer is allowed to loaded above the rated power of the transformer, etc.

Hence when monitoring a parameter such as e.g. power to know whether or not this parameter complies with the established reference value, both voltage, current and other relevant parameters may be monitored over time to determine if the present power complies with the established reference value.

In an embodiment of the invention said plurality of power consumers and said one or more decentralized power producers located at said lower voltage side of said transformer are arranged locally in said utility grid so as to form a micro grid facilitating local adjustment of the consumed power and/or power produced locally in the micro grid.

For the purpose of this document, the term micro grid is to be understood as a localized grouping of power sources such as decentralized power sources and loads in the form of power consumers that normally operates connected to and synchronous with the traditional centralized grid, i.e. the transmission lines and in some cases also the distribution lines. However, such a micro grid may also function at least partly autonomously from the centralized grid which is often part of the utility grid.

It is understood that a micro grid or a group of micro grids according to the invention at least in some embodiments may be referred to as a cluster or clusters of power consumers and power producers.

Further more a consumer group may also be referred to as a micro grid, where the micro grid does not comprise a decentralized power producer.

It is advantageous that the micro grid facilitates adjustment of the power consumption and/or power production locally over time in the micro grid, based on state of a transformer in the utility grid. This helps to protect the transformer from e.g. overload, and may also protect other parts of the grid such as cables of wires of the utility grid.

In an embodiment of the invention said control arrangement is a central control arrangement.

Hereby advantageous control of the power may be achieved.

The central control arrangement may facilitate gathering and processing of monitoring data from e.g. one or more of said transformers, data of power consumer characteristics, power producer characteristics, characteristics of consumer groups and the like so as to control said power at said lower voltage level.

However, in other embodiments of the invention, the controlling of the power at said lower voltage level may be facilitated by means of a decentralized control arrangement handling the control of the power based on the monitoring. Such a decentralized control arrangement may be associated with one specific transformer for control of the power at the lower voltage side of the transformer.

In case the control arrangement is not a central control arrangement, the control arrangement may be located e.g. in relation to or as part of a micro grid or in relation to a substation.

The central processing unit of the control arrangement is preferably a data processor or the like capable of processing data.

In an embodiment of the invention said central control arrangement facilitates individual control of the power at a lower voltage side of a plurality of transformers.

Thus, handling of more micro grids is facilitated by the same control arrangement which may be a cost efficient way of controlling a plurality of micro grids simultaneously.

Furthermore this may be advantageous in that more information of the grid is handled by the same control arrangement. This may facilitate enhanced monitoring and control of parts of the utility grid and the power at locations of the grid.

In an embodiment of the invention said transformer is a transformer with a low voltage level on the low voltage side of said transformer being a consumer voltage level.

For the purpose of this document, the term “consumer voltage level” should be understood as a voltage level which corresponds to the voltage level of a power consumer. An example of a common consumer voltage level may be a conventional one or three phase system. In a three-phase system, three circuit conductors carry each their alternating current (of the same frequency) which reach their instantaneous peak values at different times. Three-phase systems may or may not have a neutral wire. A neutral wire allows the three-phase system to use a higher voltage while still supporting lower-voltage single-phase appliances/apparatuses.

In Europe, the consumer voltage level of a lower-voltage single-phase power consuming apparatus is officially about 230 volts AC with a frequency of about 50 Hz. Some other larger apparatuses utilizes all three phases, e.g. a cooker for cooking food, heaters such as water heaters or electric radiators, motors, washing machines, electric tools at production factories and the like. Measuring between two phases of a three phase system, a result of about 400V would be obtained. Measuring between a neutral wire and a phase, a result of about 230V would be obtained. Other examples of a consumer voltage level would e.g. be 110 to 120 volts AC at a frequency of 60 Hz. Furthermore, some larger energy consuming apparatuses may consume power at a higher or lower consumer voltage level than the above mentioned.

One example of such a transformer may e.g. be a 10/0.4 transformer, i.e. a transformer for transforming voltage from a 10 kV level (Higher voltage level) to a 400V level between the three phases in the three-phase lower voltage side of the transformer which may be regarded as a consumer voltage level due to that this may be the common voltage for a power consumer or a group of power consumers.

However according to alternative embodiments of the invention the transformer may be located in the distribution lines or transformers located both in the transmission line and in the distribution lines of the utility grid. For example, a transformer may be located in a distribution lines and may e.g. transform voltage from a 50 kV level (High voltage level) to a 10 kV level (lower voltage level).

In an embodiment of the invention said method further comprises the step of establishing at least one consumer group by matching individual power consumer characteristics providing information of said power consumers,

said consumer group comprising one or more of said power consumers facilitating consumption of voltage transformed by said transformer.

This facilitates that groups of power consumers arranged at the lower voltage side of the transformer may be grouped advantageously so as to be controlled to comply with the established reference value. Likewise, such consumer groups may be utilized for establishing a cluster of one or more consumer groups and one or more decentralized power producers, where the group(s) of power consumers is/are arranged advantageously in the grid in relation to one or more decentralized power producers. An example of such an advantageous arrangement may be that the consumer(s) of the consumer group(s) are arranged near to the decentralized power producer(s) in the grid, thus giving that power is not transmitted over a larger distance giving an increased transmission loss in the grid.

In an embodiment of the invention at least one of said at least one decentralized power producer is a mobile power producer.

Mobile, decentralized power producers is a growing type of decentralized power producers due to several reasons. First of all, more and more power consumers wish to be assured that they have their own power supply in case of a breakdown at their part of the utility grid. Secondly, renewably energy e.g. in the form of wind and solar energy has aroused interest of persons which whish to take the environment into consideration when consuming electric energy. Thirdly, the development of decentralized mobile power generators has facilitated that mobile generators able to produce larger amounts of power such as e.g. over 100 kVA, over 200 kVA, or even over 500 kVA. These power generators are often utilized e.g. at temporary events such as festivals, at larger construction sites and the like.

Thus, being able to control a mobile decentralized power producer arranged at the grid, several benefits may be achieved. One benefit may be controlling the mobile power producer in case that it produces too much power giving the risk of disadvantageous loads on the transformer.

Another benefit may be to utilize the mobile power producer in case that it is determined based on the said reference value and monitoring that the transformer is to be e.g. overloaded and thus the mobile power producer may compensate for the transformer to protect the transformer.

In an embodiment of the invention said mobile power producer comprises a positioning determining arrangement being adapted to determining the geographical location of said mobile power producer, and

wherein said method comprises the step of detecting the geographical location of said mobile power producer by means of said positioning determining arrangement so as to determine the presence of said position mobile power producer in said power transmission network and/or the location of said mobile power producer in said power transmission network.

The geographical location of a decentralized, mobile power producer often changes over time, thus also changing the location of the mobile power producer in the grid.

By detecting the position of a decentralized, mobile power producer over time, it is possible to get a better impression of variations in the grid at local areas of the grid. Likewise it may be possible to determine the amount of local power recourses for more accurately regulation.

The positioning determining arrangement may comprise a GPS (GPS; Global Positioning System) arrangement, a mobile data network arrangement (e.g. 3G, 4G or the like), it may comprise a cell phone arrangement such as a GSM arrangement, or the like, to facilitate detection and determination of the location by localization methods common within the cell phone technology.

Likewise the mobile power producer may transmit information of the amount of power produced, e.g. to a central control arrangement, so as to facilitate determination of the present power produced by the mobile power producer.

In an embodiment of the invention said reference value is determined based on a rated parameter for said transformer.

A transformer is, when it is manufactured, born with a number of nominal parameters/rated parameters defining a number of characteristics for the transformer. These parameters defines preferred operational areas for the transformer such as temperature ranges, power ranges, voltage ranges, current range, intended power direction (i.e. if it is a transformer intended for being a step-up transformer and/or a step-down transformer), e.g. fluid level (if the transformer utilizes e.g. oil for cooling) etc.

Thus, by establishing the reference value(s) based on one or more of these rated parameters for the transformer and over time monitoring the parameter(s), it is possible to monitor the state of the transformer and act accordingly.

One example may be defining a reference value based on the preferred maximum rated power of the transformer e.g. by defining the reference value to be over, at or a percentage below the rated power such as 110% of the rated power, 100% of the rated power, 95% of the rated power or the like. Then, the power transformed by the transformer is measured and correlated with the established reference value. If the transformed gets near or excesses this reference value, a control of the power at the lower voltage level of the transformer may be initiated so as to keep the power transformed by the transformer below the reference value.

It should be understood that some transformers may be allowed to transform an amount of power above the rated power for a specified time span. In such cases, the time may also be monitored so as to assure that this time span is not exceeded. This may help to extend the life time of the transformer.

In an embodiment of the invention said at least one reference value is selected from a group of electric parameters, said group comprising:
the rated real power of said transformer, the rated reactive power of said transformer,
the rated apparent power of said transformer, the rated current of said transformer, or
the rated voltage of said transformer.

These parameters may be particular relevant to monitor in that these parameters reflects state of the transformer that may be especially advantageous to monitor since these parameters at least indirectly represents the work load of the transformer.

In an embodiment of the invention said at least one reference value is a reference value based on a temperature limit of said transformer.

The temperature of one or more parts of the transformer may be an indicator for the state of the transformer and may be dependent of e.g. the temperature of the ambient air as well as the transformer load. If the temperature in the transformer rises to a high level, the life time of the transformer may be reduced, or the transformer may even break down. Thus a monitoring of the temperature and an establishing of a reference value based on the temperature may be advantageous.

The reference value may e.g. be established to 90%, 95% or 100% of the rated maximum or preferred operational temperature. If the monitored temperature rises above this limit, a control of the power at the lower voltage side of the transformer may be initiated so as to keep the temperature below the reference value.

In an embodiment of the invention said at least one reference value is a reference value based on ambient parameters of the transformer such as the temperature of the ambient air,

This may be advantageous in that the ambient air may influent on or affect the temperature of the transformer and thus the allowed/preferred maximum load of the transformer. Other examples of ambient parameters may be the humidity of the ambient air and/or the pressure of the ambient air.

In an embodiment of the invention said at least one reference value relates to the direction of the power flow in said transformer.

Decentralized power producers have some benefits but should also be operated with care. If one or more decentralized power producers produce more power than power consumers can consume at the lower voltage side of the transformer, the power may have to flow from the lower voltage side to the higher voltage side of the transformer. Some transformer in the utility grid, e.g. in the distribution lines, are intended for facilitating a step-down of the voltage (i.e. transforming a voltage from a higher voltage level to a lower voltage level). In some situations, such transformers are not intended for facilitating a step-up function (transforming a voltage from a lower voltage level to a higher voltage level), and such a step-up function may be harmful to the transformer.

By establishing a reference value based on the power direction at the transformer and monitoring the power direction, it is possible to control the power at the lower voltage side of the transformer so as to keep the correct/preferred power direction, e.g. by controlling one or more decentralized power producers to produce less power and/or controlling one or more power consumers.

In general it is understood that the power at the lower voltage side may be controlled based on a plurality of establishing a reference values.

In an embodiment of the invention said at least one reference value further relates to the cost of power.

The cost of one kWh may be used by the control arrangement to determine how to control one or more micro grids or elements of these micro grids. Hence in case of low price the control arrangement may initiate power consumption and in case of high price the control arrangement may turn of unnecessary power consumption or initiate an increased power production at central power producers and/or decentralized power producers

In an embodiment of the invention said at least one reference value further relates to the load of at least part of the power transmission network.

In case part of the power transmission network is overloaded, the control arrangement may compensate this in one or more micro grids by increasing local power production or turning off locally power consumption.

In an embodiment of the invention said control of the power at said lower voltage side of said transformer comprises controlling of at least one power consumer at said lower voltage side and/or at least one decentralized power producer at said lower voltage side so as to prevent power from flowing from said lower voltage side to said higher voltages side of said transformer.

As explained above, power flowing against the intended power direction of a transformer may be harmful to the transformer. The power direction may be determined by decentralized power producers and power consumers located at the lover voltage side of the transformer. Thus, it may be especially advantageous to regulating these, preferably by means of a central control arrangement.

For example, a decentralized power plant may be regulated to produce less power or be turned off, or a power consumer may be regulated to consume more power. Both such regulations may individually, together or even simultaneously help to control the power direction in the transformer.

In an embodiment of the invention said controlling of the direction of power flow further comprises the step of controlling the power production of one or more of said centralized power producers.

If several decentralized power producers together with one or more centralized power producers are set to produce an amount of power, but the demand for power does not match this production, this may result in disadvantageous power flow in the utility grid. By regulating a centralized power producer, preferably by means of a centralized control arrangement, the power flow in the grid may be controlled to be more advantageous.

For example, owners of decentralized power plants may be promised by e.g. an energy company, a government or the like, that their decentralized power plant will be allowed to produce a defined amount of energy. However, if consumer power demands do not match the produced power, such decentralized power plants may risk that the amount of energy cannot be achieved. However, a regulation of one or more centralized power producers may result in that such defined amount of energy may be easier to comply with, and this may cause that more decentralized power plants may be established. More and more types of decentralized power plants are based on renewable energy, thus giving an advantageous effect to the environment.

In an embodiment of the invention said monitoring of said parameter reflecting the state of said transformer comprises monitoring the power factor at said transformer.

The power factor is a practical measure of the efficiency of a power distribution system. For two systems transmitting the same amount of real power, the system with the lower power factor will have higher circulating currents due to energy that returns to the source from energy storage in the load. These higher currents produce higher losses and reduce overall transmission efficiency. A lower power factor circuit will have a higher apparent power and higher losses for the same amount of real power.

The power factor of an AC electric power system may be defined as the ratio of the real power flowing to the load and the apparent power, and is a dimensionless number between 0 and 1 (frequently expressed as a percentage, e.g. 0.5 pf=50% pf).

Real power may be defined as the capacity of the circuit for performing work in a particular time. Apparent power is the product of the current and voltage of the circuit. In a purely resistive AC circuit, voltage and current waveforms are in step (or in phase), changing polarity at the same instant in each cycle.

However, where reactive loads are present such as with capacitors or inductors, energy storage in the loads may result in a time difference between the current and voltage waveforms. During each cycle of the AC voltage, extra energy, in addition to any energy consumed in the load, may temporarily be stored in the load in electric or magnetic fields, and then returned to the power grid later in the cycle. Thus, a circuit with a low power factor will use higher currents to transfer a given quantity of real power than a circuit with a high power factor. Circuits containing purely resistive heating elements (filament lamps, strip heaters, cooking stoves, etc.) have a power factor of substantially 1.0. Circuits containing inductive or capacitive elements (e.g. electric motors, solenoid valves, transformers, and others) often have a power factor below 1.0.

By monitoring e.g. the voltage and current at the transformer, the power factor may be determined. Thus, it may be possible to control reactive loads and/or power producers facilitating production of reactive energy so as to help obtaining a more advantageous power factor.

In an embodiment of the invention said monitoring of said parameter reflecting the state of said transformer comprises monitoring the voltage transformed by said transformer.

Monitoring the power may be an especially advantageous way of monitoring and determining the state of the transformer. The temperature of the transformer may be at least partly determined by the power flow since increased power flow results in an increase in the transformer temperature. Thus, by monitoring the power transformed by the transformer, a disadvantageous increase of the transformer may be prevented before the temperature increase.

In an embodiment of the invention said monitoring of said power comprises monitoring the flow of real power at said transformer.

Determining and monitoring the flow of real power may turn out to be especially advantageous in that the load types at the lower voltage side of the transformer may then be determined based hereon.

In an embodiment of the invention said monitoring of said power comprises monitoring the flow of apparent power and/or the reactive power at said transformer.

The power factor is 1 when the voltage and current are in phase. It is 0 when the current leads or lags the voltage by 90 degrees. Power factors are usually stated as “leading” or “lagging” to show the sign of the angle between the voltage and the current curves, where leading indicates a negative sign

Purely capacitive circuits cause reactive power with the current waveform leading the voltage wave by 90 degrees, while purely inductive circuits cause reactive power with the current waveform lagging the voltage waveform by 90 degrees. The result of this is that capacitive and inductive circuit elements tend to cancel each other out.

By monitoring the apparent power and/or the reactive power, it may be possible to get a better indication of the types of reactive loads and/or power producers producing reactive power, thus facilitating an advantageous control of power consumers and/or decentralized power producers so as to achieve an advantageous regulation of the power and reduce power loss in the utility grid.

In an embodiment of the invention said monitoring comprises monitoring the temperature of said transformer.

Monitoring the temperature may be advantageous due to that a transformer may have one or more temperature limits defined, indicating limits which, if exceeded, will increase the wear of the transformer and/or harm the transformer causing a breakdown. The temperature may be measured in the windings of the coils of the transformer or calculated based on knowledge of e.g. voltage, current and coil parameters.

In an embodiment of the invention said at least one reference value comprises a hysteresis.

Utilization of hysteresis may be advantageous are advantageous in that too frequent control of power consumers and/or power producers may be avoided. As an example, if the reference value is established based on a temperature and defines a maximum temperature of x° C., the hysteresis may be set to be e.g. X° C.±Y %. Thus, the regulation is initiated when the temperature is measured to be X° C.+Y %, and may be canceled when the temperature is X° C.-Y %.

Moreover the invention relates to a micro grid comprising a plurality of power consumers and at least one decentralized power producer being adapted for production of power to one of more of said plurality of power consumers (PC) micro grid,

wherein said micro grid is located at the lower voltage side of a transformer said transformer being adapted for transforming power from a higher voltage level to a lower voltage level, and
wherein said micro grid is further configured so that said plurality of power consumers of said micro grid may further consume power from a central power producer of a utility grid, said utility grid comprising transmission lines and distribution lines, where said micro grid is connected to said utility grid by means of said transformer,
wherein one or more of said plurality of power consumers and/or at least one of said least one decentralized power producer of said micro grid are controllable by means of a control arrangement,
said control being based on utility grid characteristic comprising at least one reference value being based on at least one parameter reflecting the state of said transformer, and a monitoring continuously of said at least one parameter reflecting the state of said transformer, so as to comply with said established reference value.

Such a control of a micro grid may be advantageous due to several reasons. E.g. the transformer may be protected, e.g. against overload, against critical high (or low) temperatures, against a power flow in a direction which the transformer is not intended for and/or the like.

Furthermore a more stabile and reliable utility grid may be achieved in that the local control of the micro grid may protect other parts of the utility grid.

It is in general understood that a micro grid for the purpose of this document may at facilitate at least some of the same functions and comprise at least some of the same features as described in relation to clusters.

In an embodiment of the invention the said lower voltage level is a consumer voltage level.

More over the invention relates to a micro grid according to claim 24 or 25, being controlled in accordance with a method according to any of the claims 1-19.

Moreover the invention relates to a utility grid comprising a plurality of micro grids according to claim 24, 25 or 26.

Moreover the invention relates to a grid comprising a plurality of power consumers and optionally at least one power producer, the grid being connected to a power transmission network via at lest one transformer wherein the grid is controlled according to the method of any of the claims 1-23.

The following stated embodiments are basically applicable alone or in combination with the above stated embodiments. In other words, the following embodiments may even be applicable without the limitations related to the above stated embodiments.

An embodiment of the invention relates to a method of managing transmission of power in a power transmission network, said power transmission network comprises:
at least one power producer,
a utility grid comprising power transmissions lines and substations,
a plurality of power consumers consuming power produced by said at least one power producer,
   said method comprising the steps of:
establishing a plurality of individual power consumer characteristics providing information of at least a part of said plurality of power consumers,
by means of a central control arrangement matching said plurality of individual power consumer characteristics to establish one or more consumer groups of power consumers based on said matching,
said established one or more consumer groups having a consumer group characteristic reflecting the expected consumer characteristic of said one or more consumer groups, and
by means of said central control arrangement over time monitoring the power consumed by said one or more consumer groups to validate whether the power consumed applies with said consumer group characteristic.

Hereby an enhanced monitoring of power consumers in the utility grid is achieved, and it is thereby possible to achieve enhanced monitoring of the utility grid, establish advantageous prognoses of the power in the utility grid, e.g. the power consumption at specific local areas or branches of the utility grid such as areas within specific postal numbers, specific geographical areas, areas defined by the utility grid and the like.

Based on knowledge of the consumption of power in the consumer groups it may become possible to predict future needs for power and thereby e.g. provide power producers with this information so that the power producers may schedule the production of power to comply with these needs. Hereby may be achieved that power can be consumed locally in relation to where it is produced, hence transmission of power in the utility grid is avoided at least during time with normal power consumption.

By the term “power transmission network” may be understood the entire system required from production of power to the consumption of power.

By the term “power producer” may be understood any type of large or small scale producer such as decentralized power producers and/or central power producers producing energy based on nuclear-, wave-, wind-, bio-, sun-, fossil fuel technologies etc. Some of these power producers may even combine the production of heat and power where power is a spin-off in the production of e.g. heat. Furthermore e.g. a factory or a farmer having its own power production e.g. in form of a wind turbine or solar cells may also be understood as a power producer according to an embodiment of the invention.

By the term “utility grid” may be understood a grid comprising power transmission lines such as distribution- and transmission lines (e.g. in form of over head wires or cables in the ground) for distributing electrical power in the power transmission network, energy storage facilities, substations such as transformers and/or switches, reactive and capacitive compensators, network operators and the like.

By the term “power consumer” may be understood any large or small power consumer such as a private home, a factory, a construction site, etc. consuming electrical power from the utility grid.

By the term “power consumer characteristics” may be understood every aspect describing an individual power consumer e.g. size, location in the utility grid and/or geographical location, type of consumer (factory, private home, etc.), demands/wishes defined by the power consumer, current power consumption, average power consumption, expected power consumption etc.

By the term “central control arrangement” is to be understood a grid managing arrangement which is able to retrieve the power consumer characteristics, power producer characteristics and preferably also utility grid characteristics, and based on these establish prognoses of e.g. expected power consumption and/or expected power production within a local area or branches of the of the utility grid. The central control arrangement may establish groups of power consumers e.g. based on established prognoses, demands or needs from the individual power consumers, etc. The consumer groups may comply with demands or needs from power producers and/or utility grid(s) or visa versa. The central control arrangement may establish one or more cluster(s) comprising one or more power consumer(s) and/or one or more power producer(s).

By the term “matching” is to be understood actions performed by the central control arrangement when establishing groups and/or clusters, e.g. by comparing consumer group characteristics, power consumer characteristics, power producer characteristics, evaluating established prognoses or the like. Hence characteristics of individual power consumers may at some parameters be comparable or at least partly identical. The central control arrangement is matching these power consumers and may gather these matching power consumers in one or more power consumer groups.

Furthermore the term matching is used to describe when the central control arrangement pairs one or more power consumer or power consumer groups with one or more power producers e.g. based on their ratio of produced/consumed power, geographical location, requirement to type power/type of produced power, etc.

In an embodiment of the invention said method, comprising dynamically adapting the power consumed by said one or more consumer groups based on the result of said monitoring of the consumed power so that the consumed power matches with said consumer group characteristic.

According to an advantageous embodiment of the invention, the central control arrangement communicates information of power in the utility grid to the power consumers of a consumer group. It may hereby be achieved that the individual power consumers becomes capable of adjusting their power consumption so that the power consumption of the consumer group does not exceed what is described in the consumer group characteristic.

By the term “adapting the power” may be understood any regulation of produced power and/or consumed power. The adaption of power may comprise controlling consumed power and/or produced power to apply with established prognoses, it may comprise adaption of power consumption and/or power production to control the amount of green energy and/or brown energy consumed and/or produced, adaption of power to achieve the most advantageous transmission path in the utility grid or the like.

The adaption of power is advantageous e.g. in that power loss in the utility grid hereby may be decreased because local power production may be made to comply with local power consumer demands. Thereby, it is not necessary to transmit electrical power through the power transmission lines from distant power producers relative to the consumer group. Another example of adaption of the power may be to adapt the power supplied to a consumer group so that the consumer group mainly consumes power from a power consumer selected by the consumer group.

In an embodiment of the invention said adaption comprises controlling one or more electrical power consuming units at one or more power consumers in said one or more consumer groups by means of said central control arrangement.

According to an advantageous embodiment of the invention the central control arrangement is capable of controlling the consumption of power at least part of the power consumers of a consumer group. The possibility of centrally controlling the amount of consumed power in a consumer group to stay within limits given by e.g. the consumer group characteristics is hereby achieved. Thereby the power consumption within the consumer groups preferably does not excide a predetermined limit and the power consumption is thereby known hence the production of power can be adjusted to comply with this consumption.

According to an advantageous embodiment of the invention the central control arrangement may control specific consumer units e.g. an oven or machine at a power consumer. Hereby is achieved a fast and effective adaption of the power consumption in the utility grid without regulating power produced by power producers which in some cases may be a slow and energy inefficient way of regulating/controlling the power in the utility grid.

In an embodiment of the invention said adaption comprises controlling the power produced by one or more of said power producers producing power supplied to said one or more consumer groups.

According to an advantageous embodiment of the invention the central control arrangement communicates information of consumption of power in the utility grid to the power producers. It is hereby achieved that the individual power producers becomes capable of adjusting their power production so that the production of power complies with the consumption of power from the utility grid. This may facilitate advantageous power regulation in that the power production may be adapted to the power consumed by one or more consumer groups.

According to an advantageous embodiment of the invention, the central control arrangement may communicate a prognosis, a demand regarding power regulation or the like to a power producer, and the power producer may then regulate the power based on the information received by the central control arrangement. The power producer may then communicate back to the central control arrangement that the regulation of produced power has been, will be, will not be, and/or cannot be applied with.

In an embodiment of the invention said adaption of the power produced comprises controlling the power produced by one or more power producers by means of said central control arrangement.

According to an advantageous embodiment of the invention, the central control arrangement may control the production of power at an individual power producer. Hereby is achieved the possibility of centrally adapt the amount of produced power to the power consumed by one or more consumer groups without changing the power consumption at the individual power consumers. Further, it is hereby assured that the regulation of the produced power takes place when found necessary.

In an embodiment of the invention said one or more power producers being controlled by means of said central control arrangement are one or more central power producers.

This may be advantageous especially if a larger power regulation of produced power should be performed, e.g. over a larger area should be performed.

In an embodiment of the invention said power producers being controlled by means of said central control arrangement are one or more decentralized power producers.

This may be advantageous especially if a local power regulation of locally produced power should be performed, e.g. to decrease power transmission over larger distances.

In an embodiment of the invention said control of one or more central power producers comprises by means of said central control arrangement transmitting one or more requests for regulation of the power produced by said central power plant, and

wherein said control of one or more decentralized power producers comprises by means of said central control arrangement regulating the power produced by said one or more decentralized power producers.

This may be advantageous in that central power producers may have a larger resistance to change the produced power due to the large amount of power produced and/or due to the way the power is produced, whereas power produced by decentralized power producers may be faster and/or more safe to regulate by means of the central control arrangement. Furthermore it becomes possible to combine a regulation of a decentralized power producer and a regulation of a central power producer to obtain to optimal regulation of power production e.g. the fastest of the regulation ensuring the utility grid maintains stabile.

In an embodiment of the invention said individual power consumer characteristic comprises information regarding the expected power consumption within a predetermined time span (t0-tn) of individual power consumers in said established consumer group,

wherein the consumer group characteristic of an established consumer group comprises at least one prognosis of the expected power consumption of said consumer group, and
wherein said at least one prognosis of the expected power consumption of said consumer group is established by means of said central control arrangement before said power consumption is expected to take place.

This is advantageous in that it is possible to establish advantageous prognoses regarding the expected power consumption of consumers in a consumer group based on information regarding expected power consumption of the (preferably each of the) individual power consumers in a established consumer group. It is hereby possible to establish advantageous prognoses or forecasts of the expected power consumption at specific locations in the utility grid.

In an embodiment of the invention said at least one established prognosis of the expected power consumption of said consumer group is updated at least one time before the power consumption is expected to take place.

Hereby, changes in expected consumed power over time are taken into account and more reliable and precise prognoses may be established. Thereby the production of power can be adjusted or rescheduled in time before the expected change in the predicted power consumption.

In an embodiment of the invention said central control arrangement communicates said at least one prognosis of the expected power consumption of said consumer group to one or more of said power producers.

Hereby, the power producers may adapt their produced power to local expected power consumption, hence reducing power loss due to transmission of power in the power transmission lines of the utility grid.

Furthermore, it becomes possible for the power producers related to a consumer group to perform a common adjustment or schedule their production of power to be able to comply with the future power consumption. Thereby e.g. one of the power producers may be able to perform maintenance and the like in periods with expected low power consumption, which can be complied with by other power producers related to the consumer group.

In an embodiment of the invention said plurality of individual power consumer characteristics comprises power consumer demands, and

wherein said one or more consumer groups are established based on similar power consumer demands to achieve one or more consumer groups comprising a consumer group characteristic reflecting one or more similar power consumer demands of the power consumers in said consumer group.

Hereby it becomes possible to create a consumer group with identical power consumer demands e.g. to green energy. Thereby it becomes possible e.g. to choose a specific power producer to a specific consumer group e.g. a wind power park for supplying a consumer group of power consumers demanding a high ratio of green energy.

By the term “power consumer demands” is to be understood demands/wishes and/or limitations given by a power consumer. Such demands/limitations may e.g. comprise demands/wishes regarding the type of power, e.g. green power (such as renewable energy), brown power/energy (e.g. energy produced by fossil fuel such as coal, gas or oil), that a certain amount of the energy supplied to the consumer originates from a specific power producer, or the like.

In an embodiment of the invention said plurality of individual power consumer characteristics comprises power consumption abilities of said power consumers, and

wherein said one or more consumer groups are established based on similar power consumption abilities to achieve one or more consumer groups comprising a consumer group characteristic reflecting one or more similar power consumer abilities of the power consumers in said consumer group.

This is advantageous e.g. in that power consumers may hereby more easily be monitored and/or regulated when managing the power in the utility grid.

By the term “power consumption abilities” is understood the abilities of the power consumer to consume power and may be defined based on experiential data from the power consumer, an average power consumption measured at the power consumer fuse values at the consumer or the like.

In an embodiment of the invention said power consumer characteristics comprises a plurality of power consumer parameters.

By the term “power consumer parameters” are herein understood parameters comprising information regarding the individual power consumer.

Hereby advantageous data processing may be achieved since power consumer characteristics comprising information of a power consumer is divided into a plurality of parameters which may facilitate advantageous matching of power consumer characteristics. A power consumer parameter may comprise information regarding power consumer demands and/or power consumption abilities of the individual power consumer. For example, power consumer parameters may comprise information of the location of a power consumer in the utility grid, information regarding the geographical location of a power consumer, information regarding the expected power consumption of a power consumer within a predefined time span, time limits for complying with a power consumer demand and/or power consuming task, or the like.

In an embodiment of the invention one or more settings of at least one of said power consumer parameters are continuously monitored by said central control arrangement over time.

This is advantageous in that more precise power consumer characteristic is received by the central control arrangement.

According to an advantageous embodiment of the invention, power consumer parameters comprising information regarding the expected power production of a power consumer are monitored over time to facilitate that the central control arrangement may match updated data and thereby establish more precise prognoses regarding the expected power production of a consumer group. Likewise time limits specified by the power consumer, demands regarding green/brown energy may be altered by the power consumer and by monitoring the settings of power consumer parameters comprising such information, the central control arrangement may take amendments of parameter settings into account.

In an embodiment of the invention said power consumer characteristics comprises power cost demands, and

wherein said one or more consumer groups are established based on similar power cost demands to achieve one or more consumer groups comprising a consumer group characteristic reflecting one or more similar power cost demands of the power consumers in said consumer group.

This is advantageous in that the central control arrangement may take demands regarding the cost of electrical power into consideration, e.g. when regulating one or more power consuming units at the power consumers.

In an embodiment of the invention said power consumer characteristics comprises power type demands, and

wherein said one or more consumer groups are established based on similar power type demands to achieve one or more consumer groups comprising a consumer group characteristic reflecting one or more similar power type demands of the power consumers in said consumer group.

This is advantageous in that the central control arrangement may take demands regarding the power type e.g. the ration green/brown power consumed by the consumers in a consumer group into consideration, e.g. when regulating one or more power consuming units at the power consumers.

In an embodiment of the invention said one or more power consumer characteristics comprises one or more time limits and/or time span for fulfilling one or more power consuming tasks controllable by said central control arrangement, and

wherein said central control arrangement makes sure that said one or more time span for fulfilling said one or more power consuming tasks controllable by said central control arrangement are complied with.

This is advantageous in that the central control arrangement may take time limits and/or time span for fulfilling power consuming tasks into consideration, e.g. when regulating one or more power consuming units at the power consumers. If a lack of power occurs in the utility grid, the central control arrangement is able to hold or postpone power consuming tasks until the utility grid again comprises the need amount of power. Hereby, power loss in the utility grid may be reduced because it is not necessary to import power from a distant power producer, and a stiffer/more stable utility grid may be achieved. Of course, if the power consumer requires so the power consumer is assured that the power consuming task is fulfil within the given time. In this situation it may be necessary to import power from a distant power producer.

In an embodiment of the invention said method further comprising:

establishing power producer characteristics providing information of said at least one power producer,
by means of said central control arrangement dynamically establishing a cluster of at least one power producer and one or more of said consumer groups by matching said power producer characteristics and said consumer group characteristics.

According to an advantageous embodiment of the invention the central control arrangement may match a group of power consumers with at least one power producer. It may hereby e.g. be achieved that power is consumed locally in relation to where the power is produced and thereby the utility grid is not loaded with unnecessary transmission of power.

Further, this is advantageous in that an advantageous monitoring and control of power consumed and power produced at different locations in the utility grid may be achieved.

By the term “power producer characteristics” may be understood every aspect describing an individual power producer e.g. size, location in the utility grid and/or geographical location, type of producer (decentralise- or central power producer, green or brown power production, etc.), current power production, average power production, maximum power production, etc.

In an embodiment of the invention said central control arrangement establishes a plurality of local clusters dependent on their location in the utility grid, and

wherein each of said local clusters comprises one or more consumer groups with expected local power consumption that matches the expected local power production of said one or more power consumers in each of said plurality of local clusters to minimize power loss in the utility grid due to increased transportation of power in the utility grid caused by local overproduction of power.

This is especially advantageous in that it can assure that power produced locally in the utility grid is also consumed locally, thereby reducing power loss in the utility grid.

In an embodiment of the invention said central control arrangement over time controls the power produced by said power producers in said local clusters so that said expected local power consumption matches the expected local power production of said one or more power consumers in each of said plurality of local clusters.

According to an advantageous embodiment of the invention the central control arrangement may control one or more power producers of a cluster. Hereby is obtained the possibility of continuing to have a power production matching the power consumption in a cluster even though power consumption or power production varies within the cluster without regulating at any of the power consumers. This may be an advantageous way of achieving matching local power consumption and power production.

In an embodiment of the invention said central control arrangement over time controls the power consumed by one or more said power consumers of the one or more consumer groups in said local clusters so that said expected local power consumption matches the expected local power production of said one or more power consumers in each of said plurality of local clusters.

According to an advantageous embodiment of the invention, the central control arrangement may control the power consumption of one or more power consumers of a cluster. Hereby is obtained the possibility of continuing to have a power production matching the power consumption in a cluster even though power consumption or power production varies within the cluster without regulating at any of the power producers. This may be an advantageous way of achieving matching a local power production to local power consumption.

It is understood that the control of produced power and/or consumed power may be directly or indirectly performed based on one or more prognoses established by the central control arrangement such as prognoses of the expected power consumption of one or more consumer groups and/or prognoses of the expected power production of power producers.

In an embodiment of the invention said expected local power consumption matches the expected local power production when the expected local power production is a predetermined percentage above the expected local power consumption.

In conventional utility grids overproduction of power to assure a sufficiently stiff utility grid may be uncontrolled over a larger area which leads to an unnecessary large amount of overproduced power in the utility grid. By centrally (e.g. by means of a central control arrangement) controlling overproduction of power at a plurality of local areas, so that over production of power in one area compensates for lack of power in another area, a controlled and appropriate overproduction of power is achieved to assure a stiff utility grid and at the same time a reduced total amount of overproduced power in the utility grid is achieved hereby reducing power losses in the utility grid due to reduced transportation of overproduced power.

In an embodiment of the invention said predetermined percentage corresponds to a local production of power of at least 1% above the expected local power consumption

This is advantageous in that a controlled percentage of overproduction of power helps to achieve a stiff utility grid without too much power loss due to transmission of power over longer distances.

In an embodiment of the invention said one or more power producer characteristics comprises one or more time limits and/or time span for fulfilling one or more power consuming tasks defined by said power producer, and

wherein said central control arrangement makes sure that said one or more time span for fulfilling one or more power consuming tasks defined by said power producer are complied with.

This is advantageous in that power consumers are assured that power consuming tasks which may be controlled by a central control arrangement are performed within a demanded time span, thereby giving the central control arrangement the possibility to control power consuming units without damages or disadvantages to the consumer.

According to an advantageous embodiment of the invention the central control arrangement may be allowed by the power consumer within a period of time to completely take over control of a power consuming unit at the power consumer. Hereby is achieved that in situations where the power producers are producing more power than what power consumers are consuming, e.g. during a storm with a huge amount of power produced by wind power parks, the central control arrangement is allowed to initiate power consumption on its own motion. A power consuming unit control by the central control arrangement in this situation could e.g. be large refrigerated warehouse, freezers at a plurality of private homes, radiators at a plurality of private homes, etc.

In an embodiment of the invention said power producer characteristic comprises information regarding the expected power production within a predefined time span.

This is advantageous in that the central control arrangement may establish prognoses to evaluate if the expected power consumed (e.g. within a local area near the individual power producer) matches the expected power produced, thereby giving the possibility of adapting the amount of locally consumed power to the amount of locally produced power.

According to an advantageous embodiment of the invention, the central control arrangement is informed of the expected power production from one or more power producers. Hereby may be achieved that the central control arrangement is able to plan power consumption and/or power production e.g. in the clusters in which the one or more power producers are located. Thereby, a peak consumption of a consumer group may be decreased and/or moved to comply with the expected power production. Likewise, the produced power may be advantageous controlled to comply with the expected power consumption since the central control arrangement may receive information of the expected power production.

In an embodiment of the invention at least one of said consumer groups in said cluster is a local consumer group specifically established to comprise a consumer group characteristic comprising expected power consumption complying with an expected power production of at least one local power producer (PP) in said cluster.

Hereby, it is possible to more easily establish a cluster comprising power consumer consuming substantially all the power produced by the power producers in the same cluster. It is understood that a cluster may comprise only one group of consumers established to consume substantially all the power from the power producer(s) in the cluster, but the cluster may also comprise pre-established groups of consumers consuming a part of the power produced by the power producer(s) in the cluster, and a further group established to consume the remaining power from the producer.

The cluster may hereby e.g. achieve that a group of consumers substantially matches the power production of a power producer so that a decreased amount of surplus power is transmitted over a larger distance.

In an embodiment of the invention said one or more consumer groups and/or clusters are dynamically established based on utility grid characteristic comprising information of the structure and/or behaviour of the utility grid.

Hereby it is possible to control power in the utility grid, based on the local structure in the utility grid.

In an embodiment of the invention said utility grid characteristic comprises information of the impedance of said utility grid at specific sections of said utility grid.

It should be noted that information relevant to a so-called specific section in the present context designates that the information relates to a part of the grid which is at least relatively well-defined and not just a fluffy technically non-usable information. It should however be noted that a specific section of course may include parts of the grid which is not completely specific down to the smallest detail of e.g. a transformer station, but enough to make technical sense and establish the consumer groups.

This may be advantageous since it is hereby possible to e.g. choose power transmission path in the utility grid to reduce power loss in the utility grid due to characteristics such as resistances and/or reactances e.g. a capacitances) of e.g. power transmission lines in the utility grid. Such information may e.g. be given by the utility grid characteristic by means of the equation Z=R+jX where the complex impedance Z is given by a real part, the resistance R, and an imaginary part, the reactance jX. The central control arrangement may hereby choose a transmission path in the utility grid with the lowest power loss.

In an embodiment of the invention said utility grid characteristic comprises information of reflection losses of said utility grid at specific sections of said utility grid.

According to an advantageous embodiment of the invention it is advantageous to get access to reflection losses in the utility grid to be able to compensate for this loss.

In an embodiment of the invention said utility grid characteristic comprises information of transformation losses of said utility grid at specific sections of said utility grid.

According to an advantageous embodiment of the invention it is advantageous to get access to transmission losses in the utility grid to be able to compensate for this loss.

In an embodiment of the invention the production of power produced by said one or more power producers is adapted to said utility grid characteristic to reduce transmission of power in specific sections of the utility grid.

This is advantageous since certain power transmission lines (e.g. transmission or distribution lines) especially old power transmission lines in the utility grid were dimensioned to transport a smaller amount of power than recently installed power transmission lines. Hence due to expansion of the power consumption form the utility grid e.g. because of new power consumers and/or power producers are connected to existing power transmission lines of the utility grid it is advantageous to be able to route the transmission of power through the utility grid.

In an embodiment of the invention one or more power consumers being member of a first consumer group and/or cluster are further a member of one or more other consumer groups and/or clusters.

Hereby it may be possible to monitor and/or control power consumers and/or power producers to comply with different consumer group characteristics and/or power producer characteristics of a plurality of consumer groups and/or power producers.

In an embodiment of the invention said power consumer characteristics, said consumer group characteristics and/or said power producer characteristics are stored at one or more central data bases.

Hereby power consumer characteristics, consumer group characteristics and/or power producer characteristics may advantageously be gathered and/or processed.

Moreover an embodiment of the invention relates to a software product which when run on a computer is capable of performing the method according to any of the claims.

### FIGURES

The invention will be described in the following with reference to the figures in which:

FIG. 1a illustrates an embodiment of a power transmission network,

FIG. 1b illustrates a flow diagram describing a method according to an embodiment the invention.

FIG. 2a illustrates an embodiment of a plurality of individual power consumer characteristics,

FIG. 2b illustrates an example of an established prognosis of the expected power consumption of a local power consumer group

FIG. 3 illustrates an example of an established prognosis of the expected power consumption of a local power consumer group which is amended by means of a central control arrangement according to an embodiment of the invention,

FIG. 4 illustrates an example of the expected power production of a plurality of power producers,

FIG. 5 illustrates an example of clusters comprising at least one power producer and at least one power consumer group,

FIG. 6 illustrates another example of clusters comprising at least one power producer and at least one power consumer group,

FIG. 7 illustrates an embodiment of a central control arrangement,

FIG. 8 illustrates an embodiment of a central control arrangement communicating with a plurality of power consumers and power producers,

FIG. 9 illustrates an embodiment of two central control arrangements communicating, and each communicating with a plurality of power consumers and power producers

FIG. 10 illustrates part of a power transmission network according to an embodiment of the invention,

FIG. 11 illustrates part of a power transmission network comprising a micro grid according to an embodiment of the invention,

FIG. 12 illustrates control of a lager part of a power transmission network according to an embodiment of the invention,

FIG. 13 illustrates a schematic view of a part of a utility grid comprising a plurality of micro grids, and

FIG. 14 illustrates a flow chart relating to monitoring of transformers based on an established reference value according to an embodiment of the invention.

### DETAILED DESCRIPTION

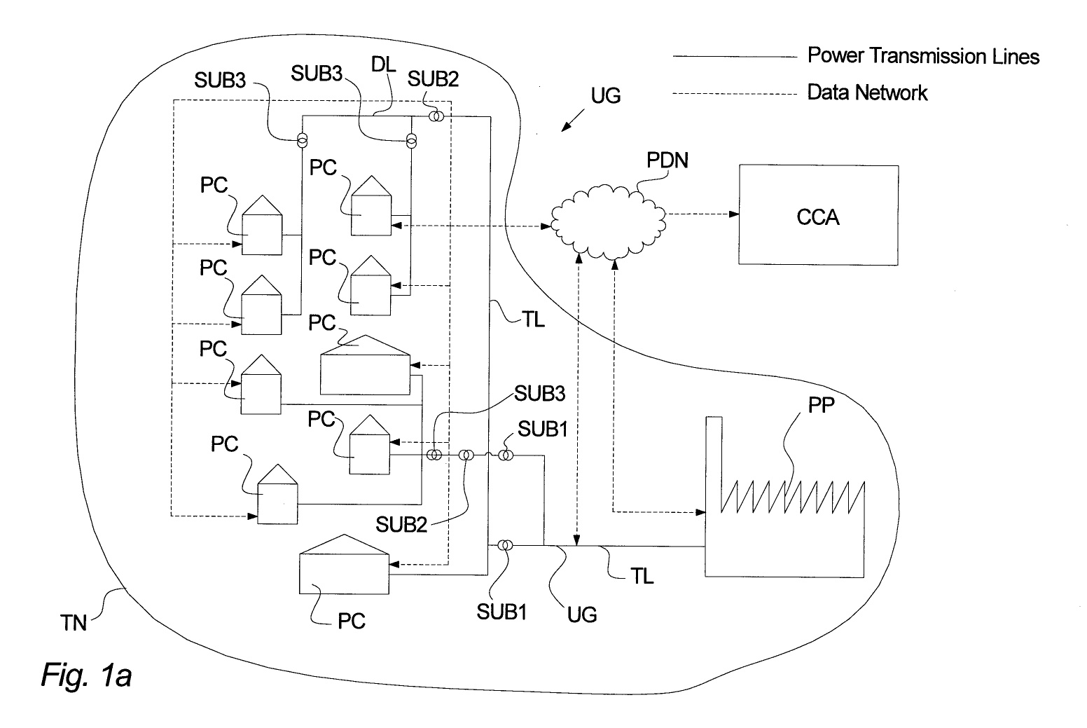

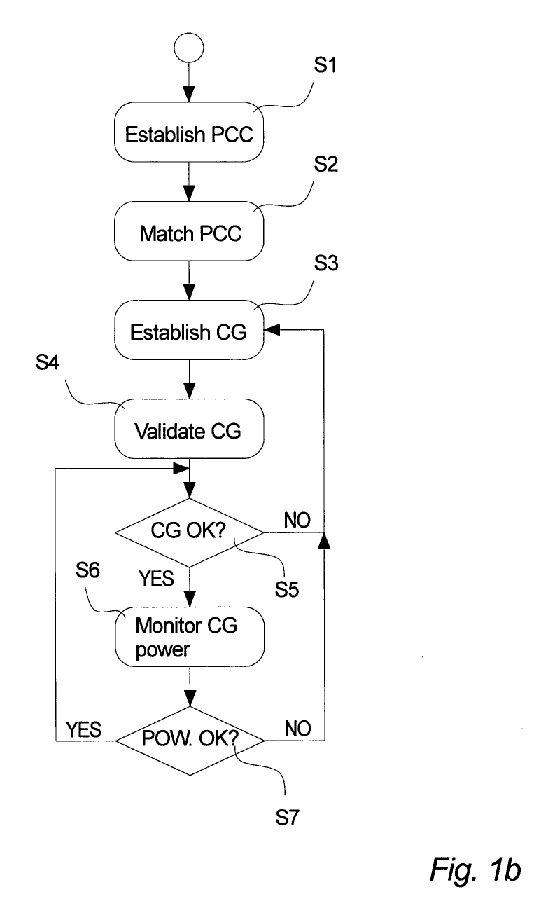

FIG. 1a illustrates a transmission network TN comprising a power producer PP, a utility grid UG and a plurality of power consumers PC consuming power produced by the power producer PP. The power producer PP may either be a central power plant CPP or a decentralized power plants DPP as described below. Furthermore, a central control arrangement CCA is (e.g. by means of a public data network such as the internet) connected to elements of the transmission network, e.g. power consumers PC power producers PP, substations SUB and the like via one or more data communication network DN. An example of data communication networks may be wired network(s) such as LAN (LAN; Local Area Network(s)), optical fibre network(s), coaxial network(s) or the like, and/or wireless network(s) such as WLAN (WLAN; Wireless Local Area Network), a mobile internet, a GSM network (GSM; Global System for Mobile communication) or any other suitable network and combinations thereof.

The utility grid UG comprises power transmission lines PTL comprising transmission lines TL and distribution lines DL distributing the electric power from the power producer PP to the power consumers PC. The transmission lines TL and/or distribution lines DL may comprise cables in the ground, overhead lines and the like.

Further, the utility grid UG comprises substations SUB which may facilitate switching, changing and/or regulating the voltage/current in the power transmission lines PTL, and that the substations SUB may connect the power producers PP to the transmission lines TL and the transmission lines TL to the power distribution lines DL. Furthermore a substation SUB may transform alternating current to direct current and vice versa.

One example of the substations SUB may be that a first substation type SUB 1 transforms the voltage from a power producer PP from a first voltage, to a second lower voltage, e.g. 150 kV to 50 kV alternating current. Hereafter a second type of substations SUB 2 transforms the voltage from the second voltage to a lower third voltage, e.g. from the 50 kV to 10 kV alternating current, and a third type of substations SUB3 transforms this voltage from the third voltage to a lower fourth voltage, e.g. from 10 kV to 400V AC alternating current. It is understood that the transmission lines TL and/or distribution lines DL may comprise a plurality of different voltages e.g. from 230V to 400 kV and different types of electricity (AC or DC) known to the skilled person.

As a main rule there are two types of power producers PP producing electrical power to the utility grid UG. The first type is a central power plant CPP. A central power plant CPP may be defined as a large power producer PP in the sense that it produces a large amount of electricity, e.g. above 200 MW, which is typically distributed to a larger area around the central power plant CPP. Most common energy sources of central power plants are coal, hydropower (comprising one or more dams), gas, nuclear power or the like. In some cases, wind parks comprising a plurality of wind turbines may, also be considered as a central power plant CPP.

For the purpose of this application, by the term “power” or “electrical power” is herein understood e.g. real power, reactive power and/or any combination of real power and reactive power resulting in an apparent power which is the vector sum of active and reactive power as known to the skilled person.

The second type of power producers PP are decentralized power plants DPP, also known as distributed power generation or on-site generation. A decentralized power plant DPP may be defined as smaller electrical power producers such as local power producers which could have the main goal of generating heat for e.g. district heating, and where the generated electrical energy is a “spin off” of the heat generation, etc. An example of the amount of electrical energy produced by a decentralized power plant DPP may e.g. be between 1 MW (or even less such as smaller wind turbines, local generators, solar cells, biogas plants generating power by means of e.g. slurry etc.) up to e.g. 100 MW. Most common energy sources of decentralized power plants DPP are natural gas, solar power, wind power, generators (e.g. driven by fossil fuel), hydro electric power (e.g. produced by wave energy) etc.

One advantage of decentralized power plants DPP is that such power plants are often power plants placed locally and the loss of energy in transmission lines TL and/or distribution lines DL, during transmission of energy (electricity and/or heat) from these decentralized power plants DPP, should hereby be significantly reduced since the power is intended to be delivered locally.

The electrical energy from the centralized power plants CPP and decentralized power plants DPP may be supplied directly or via one or more substations SUB to the power transmission lines PTL of the utility grid UG.

Due to the fact that the central power plants CPP and decentralized power plants DPP do not know the specific needs of power in the grid, the power producers PP are forced to make considerable overproduction of power, also known as overproduced power or excess power to assure a stable/stiff utility grid UG, i.e. a utility grid comprising a voltage and/or frequency which substantially do not vary dependent on the load on the utility grid UG. However, this increases the demands to the structure of the utility grid UG, and if the power consumers PC cannot consume most of the power from the power producers PP nearby, the overproduction of electrical power will unavoidably cause transmission of power over large distances, hence increase power loss significantly.

By monitoring the characteristics of individual power consumers PC and preferably also power producers PP in the utility grid UG according to the an embodiment of invention, it will be possible for the central control arrangement CCA to establish a plurality of more precise prognoses of the expected and current power consumption and power production, and hereby it is possible to predict problems caused e.g. by meteorological conditions, overproduction of power, predictable or non-predictable needs from power consumers PC and the like.

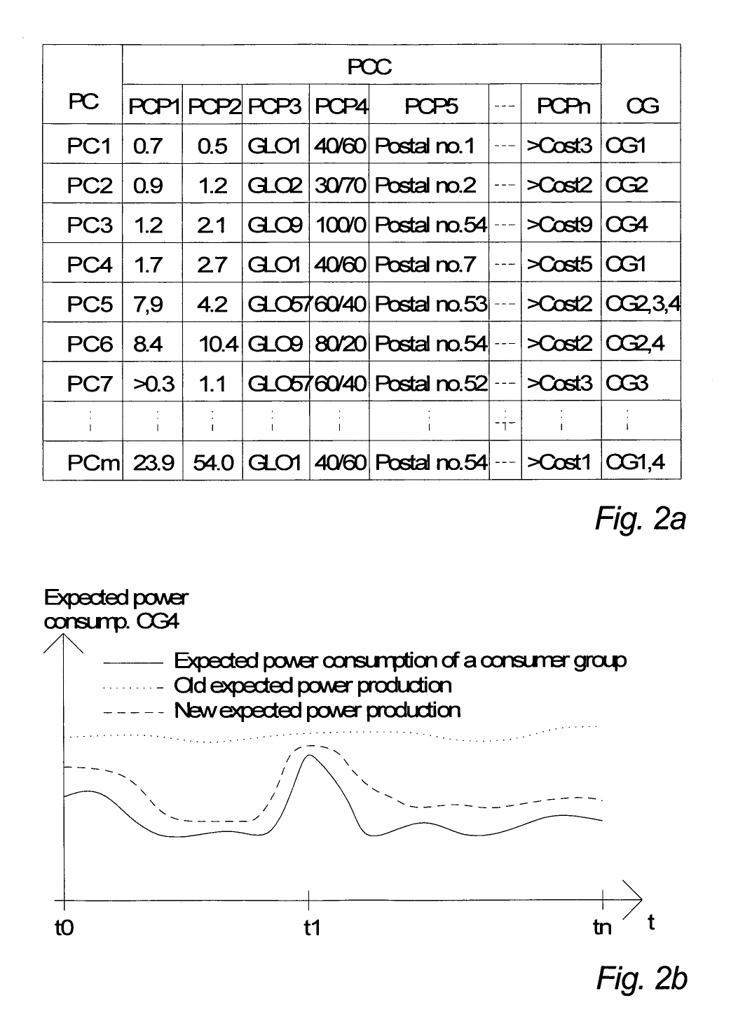

According to an embodiment of the invention, the power consumers PC in the utility grid UG therefore each comprise an individual power consumer characteristic PCC as described in more details in relation to FIG. 2a. This power consumer characteristic PCC of each power consumer PC in the utility grid UG may e.g. comprise power consumer demands which is to be understood as demands determined by the individual power consumer PC, and may comprise power consumer parameters PCP such as:
Demands/wishes from the power consumer PC, e.g. a specification of an amount of green energy supplied to the power consumer PC (e.g. produced by renewable energy such as wind energy, water energy or solar energy). For example, the power consumer PC may demand that at least 40% of the power consumed is made from renewable energy,
Demands defined by the power consumer PC regarding when and/or how power consuming electrical appliances/units at the power consumers PC site may be controlled e.g. started or stopped by the central control arrangement CCA,
Demands regarding specific preferred power producers PP,
Demands regarding the electrical power cost, e.g. so that the power consumer PC may define a maximum allowed cost for the electrical power consumed,
Demands regarding a time limit for complying with a demand and/or power consuming task (especially in embodiments where the central control arrangement CCA may control power consuming units at a power consumer PC).
Demand regarding a upper limit of power consumption (e.g. to establish a consumer group having a maximum power consumption, and the power consumers PC in the consumer group may be controlled based on this limit),
Etc.

Likewise, the individual power consumer characteristic PCC may comprise information regarding power consumption abilities of the individual power consumers PC. These power consumption abilities may e.g. comprise power consumer parameters PCP such as:
Logged/stored data regarding the consumed power at specific time periods,
Current power consumption,
The amount of active power and/or reactive power consumed
Expected power consumption within a predefined time span (e.g. comprising information from the power consumer PC regarding forthcoming power consuming tasks)
Expected average power consumption within a predefined time span,
Power quality at the power consumer PC (voltage, frequency, waveform characteristic etc.),
The maximum possible power consumption (e.g. given by the electrical installation and/or fuses at the power consumer PC),
Regulation possibilities at the power consumer PC accessible from an external location,
Information regarding the individual power consumer's PC connection to the utility grid UG, e.g. the location of the power consumer PC in the utility grid UG,
The geographical location of the individual power consumer PC, e.g. given by the postal number, coordinates such as GPS coordinates (GPS; Global Position System), address or the like.
Etc.

It is understood that the above examples of power consumer characteristic PCC are non-exhaustive, and may comprise any suitable information regarding the individual power consumer PC.

FIG. 1b illustrates a flow chart describing one example of a preferred embodiment of the invention wherein a plurality of individual power consumer characteristics PCC are established and matched to establish one or more consumer groups CG of power consumers PC.

In Step S1, the above mentioned power consumer characteristics PCC are established by the central control arrangement CCA, e.g. by means of continuous measuring, estimations and/or statistic analysis, by agreements with power consumers PC regarding agreed power consumer demands, etc.

It should be noted that the power consumer characteristics PCC may be created e.g. from continuous measurements from the power consumer PC provided to the central control arrangement CCA and/or knowledge of the power consumers PC which is predefined and stored e.g. in or external to the central control arrangement CCA. It is understood that the power consumer characteristic PCC may comprise information which changes over time, e.g. current power consumption, expected power consumption, demanded ratio between green and brown energy/power or the like, and information which does not change at all or changes very rarely, e.g. geographical location, location of a power consumer PC in the utility grid UG, the maximum possible power consumption (e.g. given by fuse value(s) at the power consumer).

Likewise, it is understood that the gathering of power consumer characteristics PCC may e.g. be achieved by means of one or more data communication networks DN e.g. by using a public data network PDN as explained above in relation to FIG. 1. Likewise, power consumer characteristic PCC may be gathered from one or more databases, e.g. located at power producers PP or operators of the utility grid UG or the like, comprising or having access to power consumer information/characteristics PCC.

In an embodiment of the invention, information regarding the power consumption abilities of a power consumer PC may be gathered by communication with the existing electricity meters arranged at the power consumers PC, as well as other units/component at the power consumer PC. Existing electricity meters at the power consumers PC are getting more and more sophisticated and may comprise an internet connection, wireless communication capabilities such as GSM, Bluetooth, WLAN or the like. Hereby it may be possible to gather information regarding e.g. the grid location and/or geographical location of the power consumer PC (e.g. by accessing the electricity meter identification whereby it may be possible to determine a postal address), current and historical power consumption, voltage quality (to determine the deviation from the wanted predetermined voltage such as 230V or 400V and frequency of e.g. 50 Hz or 60 Hz) and the like.

The individual power consumer characteristics PCC are in step S2 processed by the central control arrangement CCA. The central control arrangement CCA match power consumers PC having power consumer parameters PCP which are comparable or at least partly identical. This matching may e.g. be based on statistic analysis, comparisons, meteorological data, knowledge of the physical structure of the utility grid UG, etc.

In step S3 one or more power consumer groups CG are established, e.g. based on a predetermined set(s) of rules, from the matching of the individual power consumer characteristics PCC made in step S2.

The established power consumer group(s) CG comprise a consumer group characteristic which reflects one or more characteristic of the power consumers PC in the established power consumer group CG.

It is preferred that the established consumer group characteristic reflects a number of power consumer characteristics PCC with one or more common/similar power consumer parameters PCP reflecting one or more similar power consumer demands and/or power consumption abilities such as e.g. the geographical location of the power consumers PC, matching demands to the type of consumed energy, same power cost demands, that a power consuming task is expected to initiate at substantially the same time, that expected power consumption is in the same time interval and/or the like.

It is generally understood that prognoses established by the central control arrangement CCA may also be considered to be a part of a consumer group characteristic or a power producer characteristic PPC where the power producer characteristics PPC comprises information of the power producers PP as described below. As an example, a prognosis regarding the expected consumption within a time span t0-tn of a consumer group CG may be considered as a part of the consumer group characteristic of the consumer group CG of which the prognosis is established.

Another example may be that, an established prognosis regarding the expected production within a time span t0-tn of one or more power producers PP may be considered as part of a power producer characteristic PPC of the power producer(s) PP of which the prognosis is established.

In general, it is preferred that especially larger power consumers PC such as factories, refrigerated warehouses, construction sites and the like are continuously monitored to gather information relevant to/comprised in the power consumer characteristic PCC of these large power consumers PC. This is because such larger power consumers PC may have a (at least local) significant influence on the stability of the utility grid UG and because the power consumption of such power consumers PC may vary significantly over time and this variation may be unpredictable.

As an example, large power consuming units at factories such as large ovens (e.g. for drying wood, burning tile or bricks on tile/brickworks), large motors having a large energy consumption especially during start-up and the like, may cause shorter or longer lasting significantly increased power consumption. Network operators and/or power producers PP have to take these significant varying power consumptions into account, and since they do not know when the power consumption start and stop they are forced to produce an amount of power over a long time span, which is often unnecessary large to, at any time, be able to comply with the varying demands from the larger power consumers PC.

It is understood that even though it is preferred that it is larger power consumers PC from which the power consumer characteristics PCC are established/gathered, power consumer characteristic PCC of smaller power consumers PC such as private homes, apartment buildings and the like may also in an embodiment of the invention be established and/or gathered even though the power consumption of such smaller power consumers PC is more predictable.

In step S4 and S5, the central control arrangement CCA validates and monitors the established consumer group(s) CG over time, e.g. by matching the consumer group characteristic with updated power consumer characteristic PCC, established prognoses (explained below) and the like. If the power consumer characteristic PCC of the power consumers PC in the consumer group CG no longer apply with the consumer group characteristic, a new consumer group CG may be established, and e.g. an alarm may be set.

It is understood that the central control arrangement CCA in step S6 and S7 over time monitors the power consumed by the consumer groups CG to validate if the power consumed by the consumer group CG applies with the consumer group characteristic.

FIG. 2a illustrates an example of a plurality of power consumers PC1-PCm. Each individual power consumer PC comprises a power consumer characteristic PCC. In this example the power consumer characteristic PCC comprises a plurality of power consumer parameters PCP1-PCPn, and each of these parameters comprises information of the individual power consumer PC, and together these power consumer parameters defines the power consumer characteristic PCC of the individual power consumers PC.

It is understood that a power consumer parameter PCP may comprise one or more settings comprising information regarding the individual power consumer PC.

As an example, power consumer parameter PCP1 of the power consumer characteristic PCC may comprise information regarding the present power consumption in kW of the individual power consumer PC.

Power consumer parameter PCP2 may comprise information regarding the expected power consumption in kW within a predetermined time span (e.g. defined/set by the power consumer PC and/or by experiential data).

It is understood that a power consumer characteristic PCC may comprise a plurality of power consumer parameters PCP comprising information regarding the expected power consumption of a power consumer PC. Such power consumer parameters PCP may e.g. refer, to one or more power consuming unit at a power consumer PC, one or more power consuming unit at power consumer PC controllable by the central control arrangement CCA, a general trend/graph comprising the estimated power consumption within a predefined time span or the like.

Power consumer parameter PCP3 may comprise information regarding the location of the power consumer PC in the utility grid UG.

Power consumer parameter PCP4 may comprise information regarding the desired ratio between the types of consumed power determined by the power consumer PC (e.g. the power consumer PC desires a green/brown energy profile of 40%/60%).

Power consumer parameter PCP5 may comprise information of the geographical location of the power consumer, e.g. determined by postal number (as illustrated), by GPS coordinates or the like.

Power consumer parameter PCPn may comprise information regarding the desired maximum electricity cost per energy unit such as 1 kW.

As illustrated in the rightmost column in FIG. 2a, power consumer groups CG are established, in this case four consumer groups CG1-CG4.

It is understood that the example in FIG. 2a is a non-exhaustive example which is composed to ease the readability and intelligibility of the example, and it is understood that numerous individual power consumer characteristics PCC comprising numerous different power consumer parameters PCP may be established and matched to establish a plurality of consumer groups CG comprising various consumer group characteristics.

The first consumer group CG1 in the example in FIG. 2a comprises power consumer PC1 PC4 and PCm since they are arranged at substantially the same location in the grid GLO1.

The grid location GLO of a power consumer PC may be determined by which transformer the power consumers PC are connected to. If more than one power consumer PC is connected to the same transformer, they are located at the same grid location GLO and are therefore a member of the same consumer group CG e.g. CG1.

The consumer group CG2 is in this case established based on the consumer demands regarding a maximum cost for the electricity. Since power consumers PC2, PC5 and PC6 has the same demand to the electricity cost, these power consumers PC are member of the same consumer group CG2.

The consumer group CG3 is established based on power consumers PC requirements to the green/brown energy ratio. In this case the power consumers PC5 and PC7 both wish the same ratio being 60% green energy and 40% brown energy and they are also in the same grid location GLO 57 hence the power consumers PC5 and PC7 are therefore a member of the same (the third) consumer group CG3.

The central control arrangement CCA may hereby evaluate if there is a possibility to adapt/adjust power consuming units at the power consumers PC in the consumer group CG3, and or adjust power plants PP near the power consumers in the third consumer group CG3 to, over time, comply with the demand of at least 60% green energy. This may be done by e.g. controlling power consuming units at the power consumers PC in the consumer group CG3 so that they are turned on when there is a larger amount of green energy in the utility grid UG, and/or turn them off or adjust them to consume less energy when there is a small amount of green energy in the utility grid UG.

The consumer group CG4 is an example of a consumer group CG which is established based on the expected local power consumption of power consumers PC within a specified time span t0-tn in a local area. In this example, the central control arrangement CCA evaluates the expected power production within the area comprising the postal numbers 53 and 54 to determine a prognosis of the resulting estimated local power consumption in that area. The central control arrangement CCA establish the fourth consumer group CG4 comprising the power consumers PC3, PC5, PC6, and PCm since they are located within the relevant area. Hereafter, the central control arrangement CCA may determine a prognosis of the resulting estimated power consumption of the third consumer group CG3. This may e.g. be achieved by the equation below if the power consumer parameter PCP2 comprises information regarding expected average power consumption within a predefined time span, e.g. the next twelve hours:

$$CG {4}_{exp . pow . cons .} \begin{matrix}= ΣCG {4}_{PCP 2} \\ = PC {3}_{PCP 2} + PC {5}_{PCP 2} + PC {6}_{PCP 2} + {PCm}_{PCP 2} \\ = 2.1 + 4.2 + 10.4 + 54 \\ = 70.7 MW\end{matrix}$$

Likewise, a power consumer parameter PCP may comprise a larger amount of information regarding the expected power consumption of the power consumers PC in a consumer group CG e.g. to specific times/time spans, and the central control arrangement CCA may establish a prognosis, e.g. comprising a look up table and/or a trend/graph as illustrated in FIG. 2b based on this information. The example of such a prognosis of the expected power consumption of consumer group CG4, the solid line in FIG. 2b, is established in FIG. 2b by summing up expected power consumption to specific times/time spans t0-tn of each power consumer PC in the consumer group CG4.

In an embodiment of the invention, the information comprised in the power consumer characteristic PCC of the individual power consumers PC, may be interpreted as a prognoses of the expected power consumption within a predefined time span at the individual power consumer PC. The central control arrangement CCA may then establish a resulting prognosis of expected power consumption based on information from a plurality of power consumer characteristics PCC received from a plurality of power consumers PC.

It is generally understood that prognoses regarding the expected power consumption and/or power production may be determined/calculated by means of any suitable method and combinations of methods known by the skilled person, e.g. by means of statistic analysis, estimations, experiential data, metrological data, comparisons and/or the like, and that it is theoretical prognoses.

The resulting expected power consumption of the power consumers PC in the consumer group CG4 comprising power consumers PC3, PC5, PC6 and PCm within the postal numbers 53 and 54 are now known by the central control arrangement CCA. Hence the central control arrangement CCA may create and communicate a prognosis of the expected power consumption to one or more power producers PP (preferably the power producers PP closest to the power consumers PC), and these power producers PP may then take action to adapt the produced power to the prognosis of the expected power consumption in the consumption group CG4.

This is further explained in relation to FIG. 2b. The prognosis of the power consumption is illustrated by the solid line, with a peak at time t1. This prognosis of the expected power consumption is, as described above, established by the central control arrangement CCA from power consumption characteristics PCC received from the power consumers PC of the consumer group CG4. In this example the prognosis of the expected power consumption is established within the time span t0-tn. The peak at t1 is an example of one or more power consumers PC which have informed the central control arrangement CCA (e.g. by means of the power consumer characteristic PCC or real time data communication) that at the time t1, an increased power consumption e.g. due to initiating one or more planned power consuming task(s). An example of such a scenario may be that a device with large power consumption, e.g. a large motor, a boiler, an oven or the like, located at a power consumer PC, is planned to start up.

The established prognosis regarding power consumption expected by the consumer group CG4 (the solid line) is preferably validated over time, and is communicated/transmitted to power producers PP located near the consumer group CG4, preferably within and/or near the postal numbers 53 and 54.

Hereby, the power producer(s) PP is/are given the opportunity to adapt the power production over time to comply with the peak consumption a time t1 instead of being forced to assure a power production enabling the power consumers PC of consumer group CG4 at any time during the time span t1-tn to initiate power consumption reflected by the peak consumption at t1. The latter scenario is illustrated by the dotted line in FIG. 2b, which at any point in the time span t1-tn is larger than the peak at t1. Instead the power producers PP may settle with a production as illustrated by the dashed line following the expected power consumption (solid line), of course with an offset to ensure enough power in the utility grid for consumption deviations from the expected power consumption e.g. due to unexpected power consumption, power consumption from smaller power consumers or power consumers which may not be included in the prognosis of the expected power consumption.

It is hereby possible to reduce overproduction of power and hereby reduce power losses in the utility grid UG due to power transmission over long distances, since the power producer(s) PP, preferably power producers such as decentralized power producers DPP nearest the power consumer PC or group of power consumers CG now have a more precise indication of the expected power consumption.

In another embodiment of the invention, the central control arrangement CCA is configured for at least partly controlling the power produced by one or more power producers PP, preferably decentralized power producers DPP, but it may also be central power producers CPP.

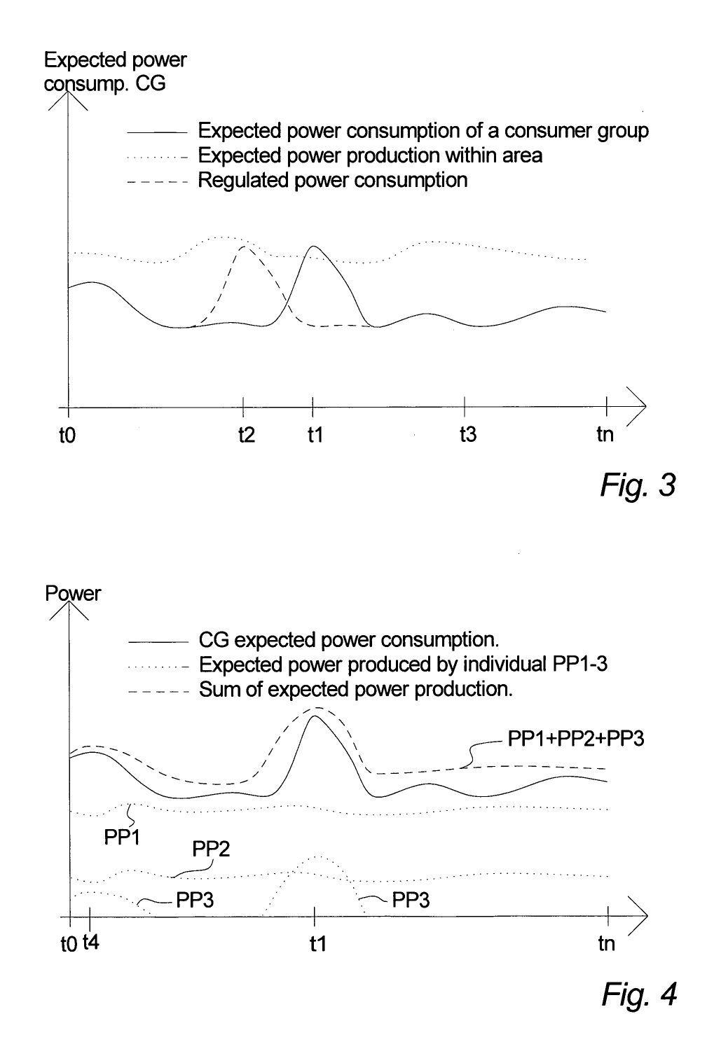

FIG. 3 illustrates an embodiment of the invention, wherein the central control arrangement CCA facilitates regulation of one or more power consumers PC in a consumer group CG.

The solid line in FIG. 3 illustrates a prognosis established by the central control arrangement CCA, as described in relation to FIG. 2b, indicating the expected power consumption within a predefined time span t0-tn. At time t1, increased power consumption is expected in the consumer group CG e.g. due to a planned power consuming task at one or more power consumers PC in the consumer group GC. The expected peak consumption at time t1 may e.g. originate from start-up of one or more large power consuming units such as boilers, heaters, cooling arrangements, ovens or the like. According to this embodiment of the invention the central control arrangement CCA is at least partly controlling some of these power consuming units.

It is understood that as mentioned above, the central control arrangement CCA may also communicate the prognosis to one or more power producers PP, preferably nearest the power consumers PC in the consumer group CG.

Further, it is understood that the power producer(s) PP may inform the central control arrangement CCA (by means of the power producer characteristic(s) PPC explained in more details below) their expected power production (the dotted line) within a predefined time span. Based on a correlation of the expected power consumption and the expected power production the central control arrangement CCA may determine that the expected local power production near the consumer group CG as illustrated at the time t1 (the dotted line) will most likely not comply with the expected power consumption at t1 (the solid line).

The central control arrangement CCA may then evaluate if the expected produced power comply with the power demands at t1 at another time within the time span t0-tn. In this example the expected power production at t2 complies with the expected power consumption at t1. Therefore, the central control arrangement CCA may facilitate adjustment of the start-up time for one or more of the large power consuming units at the power consumers in the consumer group CG, this to achieve that the power consumption at t1 is being moved to t2 where enough power is expected to be produced locally. The regulated power consumption of the consumer group CG is in FIG. 3 as a dashed line.

Hereby, the power producers PP do not have to adjust the produced power to comply with the power demand at t1, and it is not necessary to transmit power from power producers PP distant to the consumer group CG to the consumer group CG, hereby decreasing power losses in the utility grid UG.

In an embodiment of the invention, the central control arrangement CCA is configured for controlling power consuming units so that the local power consumption is distributed over a predetermined time span t0-tn. The power consumer PC in this embodiment preferably informs the central control arrangement CCA, via the power consumer characteristics PCC, which power consuming units the central control arrangement CCA is allowed to control and within which time span the central control arrangement CCA is allowed to control these power consuming units.

In a preferred embodiment of the invention, power consumers PC may demand that power consuming tasks, which the central control arrangement CCA may have access to control, should be completed within a predetermined time limit. I.e. the power consumer PC may specify a time limit for fulfilling the task, e.g. that the power consuming task(s) illustrated as peaking at time t1 in FIG. 3 should be completed before time t3. The central control arrangement CCA may hereby control when the task is carried out within this time limit set out by the power consumers PC assuring that this demand is applied with. At the same time power variations and/or power losses in the utility grid UG can be decreased because the need for additional power from distant power producers PP or increased local power production is eliminated.

In a preferred embodiment of the invention, the individual power producers PP may be described by power producer characteristics PPC, as mentioned above, comprising information regarding the power producer PP. The power producer characteristic PPC may e.g. comprise information regarding power production ability and flexibility of the individual power producer PP and/or power consumption demands, examples hereof may be:
Expected power production within a predefined time limit,
Current power production,
Maximum power production ability,
Minimum production ability,
Location in the utility grid,
Geographical location,
Demands regarding power consumption at a specific time or time span,
Type of power produced such as green energy, brown energy or the like.
Demands regarding a time limit for complying with a demand from the power producer, e.g. a demand regarding that an overproduction of power is present and that this should be adjusted for by adjusting other power producers and/or power consumers to reduce overproduction of power.
Inertia, preferably comprising time constants describing the time span from a power regulation by a power producer is demanded and initiated at the time a power producer fulfils the demand, i.e. the delay from the order to the fulfilling of the order.
Etc.

These power producer characteristics PPC are evaluated by the central control arrangement CCA and one or more prognoses regarding expected power production (e.g. as the dotted line illustrated in FIG. 3), regarding current power production and regarding types of power produced and the like may hereby be established by the central control arrangement CCA.

It is understood that the power producer characteristics PPC may comprise a plurality of parameters, each comprising one or more settings, as the power consumer characteristics PCC explained above.

It is preferred that the power producers PP generates a predefined percentage more power than expected by the established prognoses of expected power consumption, e.g. 5%, 10%, 15%, 20% or the like to make the utility grid more stable/stiff. In this way the influence of sudden unpredicted start-up of power consuming units, short circuits in the utility grid UG, break down of power producers PP, etc. is minimized, i.e. varying voltage or frequency in the utility grid UG may be avoided.

In an embodiment of the invention, the central control arrangement CCA therefore establishes a prognosis to determine the expected overproduction of power within a predetermined time span by means of power producer characteristics PPC of a plurality of power producers PP, and may thereby regulate and/or inform one or more power producers PP regarding the amount of overproduction of power they should assure to achieve a appropriate stable/stiff utility grid UG, without an unnecessary large overproduction of power.

FIG. 4 illustrates a further embodiment of the invention, wherein the central control arrangement CCA establishes a plurality of prognoses for the power production of power producers PP1-PP3 located in geographical presences of a power consumers PC of a consumer group CG. The prognosis of the expected power consumption of the consumer group CG (the solid line) may then be matched with an established prognosis (the dashed line) of the resulting expected power production of the individual power producers PP1-PP3 (the dotted lines). Hereby the central control arrangement CCA may predict the need for power and e.g. regulate one or more of the power producers PP1-PP3, and/or inform one or more of the power producers PP1-PP3 that a regulation should be performed.

In the example in FIG. 4, the three dotted lines represent the prognoses of the expected power produced by the individual power producers PP1-PP3. The central control arrangement CCA compares the prognoses for the expected power consumption (the solid line) and the prognoses for the expected power production of power producers PP1 and PP2 (two of the dotted lines) and concludes that at time t1 and time t4 there is not enough power produced locally by the power producers PP1 and PP2 to comply with the estimated power consumption. Therefore the central control arrangement CCA informs a third power producer PP3 of an amount of energy that the third power producer PP3 should produce at time t1 and time t4, hence the summation of the power produced by all three power producers PP1-PP3 (the dashed line) complies with the estimated power consumption.

This is especially advantageous if the power producers PP1 and PP2 are power producers with limited regulation possibilities and/or a large inertia, i.e. a large resistance for changing the power production, thereby having a large time constant for altering the produced power. The third power producer PP3 may facilitate faster and more dynamic power regulation i.e. have a lower inertia and thereby a lower resistance for changing the power production. It may hereby facilitates a faster and more efficient power regulation to include power produced by power producer PP3 instead of regulating on the power produced by power producer PP1 and PP2.

In a preferred embodiment of the invention, the central control arrangement CCA dynamically establishes one or more clusters C of at least one power producer PP and one or more of said consumer groups CG by matching power producer characteristics PPC and consumer group characteristics.

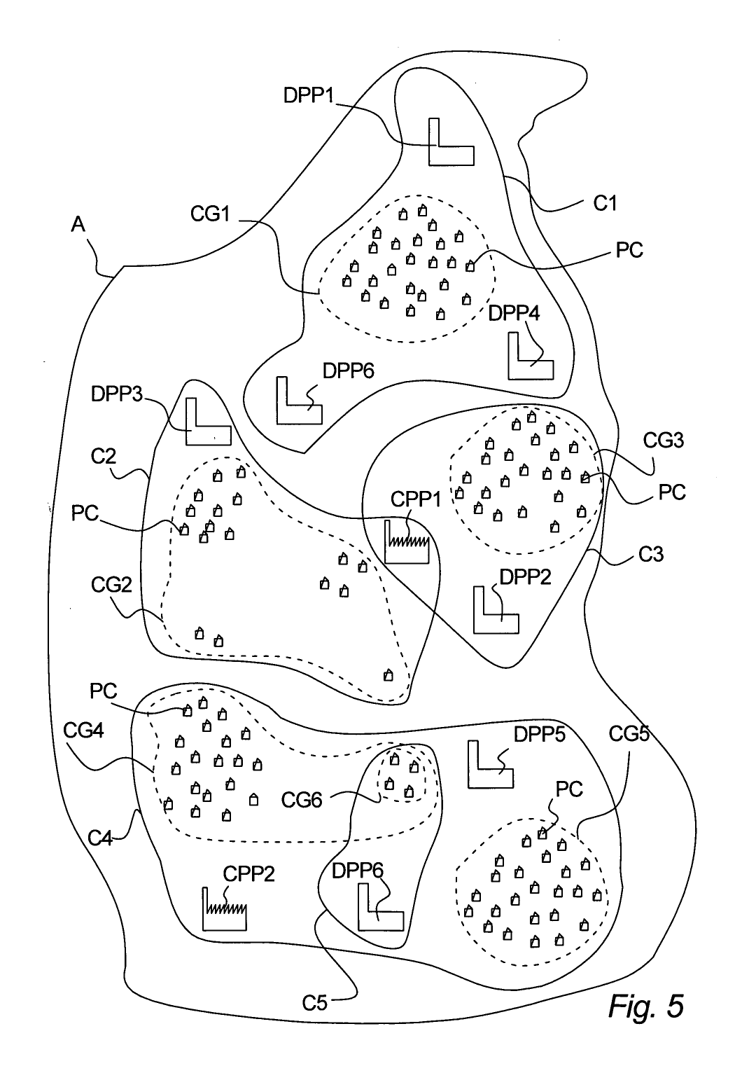

In FIG. 5, the power producer characteristic PPC from one or more of the power producers DPP1-DPP7, CPP1, CPP2 within a predetermined area A is provided to or gathered by the central control arrangement. Furthermore one or more prognoses regarding the expected and/or current power production within a predefined time span in the predetermined area A is established by the central control arrangement CCA.

Likewise the central control arrangement establishes consumer groups CG comprising a one or more power consumers PC described by consumer group characteristics, as described elsewhere in this document.

The area A may simply be an area determined by geography, infrastructure of the utility grid (UG), etc. e.g. established or defined based on power consumer characteristics PCC and/or power producer characteristics PPC, by one or more postal numbers, by a region of a country or the like. Furthermore, it is understood that the area A may be defined based on the physical or geographical structure of the utility grid UG.

The central control arrangement CCA (not illustrated in FIG. 5) matches the one or more prognoses of the expected power production of the one or more power producers DPP1-DPP7, CPP1, CPP2 within this area A with established consumer group characteristics(s) of consumer groups CG1-CG6 within the same area. The central control arrangement CCA may establish one or more consumer groups CG based on the consumer group characteristics within the area A e.g. with an expected power consumption matching the expected power production of one or more power producers DPP1-DPP7, CPP1, CPP2 or combinations thereof.

The central control arrangement CCA then dynamically establish one or more clusters C1-C5 of power producer(s) PP and consumer groups CG1-CG6 within the area A. The clusters C1-C5 and consumer groups CG1-CG6 may be dynamically altered over time e.g. to assure that the expected power production within the clusters C1-C5 matches the expected power consumption of power consumers PC within the area A.

It should be noted that even though the utility grid UG is not illustrated on FIG. 5, the power consumers PC and the power producers PP illustrated by decentralised power producers DPP and centralised power producers CPP are interconnected by means of substations SUB and power transmission lines.

A first example of a cluster in FIG. 5 is cluster C1 comprising a consumer group CG1 and the three decentralized power producers DPP1, DPP4 and DPP6, which are geographical located nearest the power consumers PC of the consumer group CG1. The cluster C1 may be established by the central control arrangement CCA by matching prognoses regarding the expected power consumption of the consumer group CG1 with prognoses of the expected power production of the decentralized power producers DPP1, DPP4 and DPP6, within a predefined time span t0-tn.

It should be noted that the central control arrangement CCA may evaluate a plurality of combination of power consumers PC and power producers DPP and CPP to end up with the right match, here illustrated e.g. as cluster C1. The first cluster C1, is created by the central control arrangement CCA if the prognoses of expected power production and expected power consumption within a predetermine time span of, e.g. a half hour, an hour, six hours, twelve hours, 24 hours or the like matches or is/may be controlled to match.

Likewise, FIG. 5 illustrates an example wherein the second cluster C2 comprises a decentralized power producer DPP3, a central power producer CPP1 and a consumer group CG2, and where the third cluster C3 also comprises the central power producer CPP1, another decentralized power producer DPP2 and a third consumer group CG3. The clusters C2 and C3 may be established like this e.g. because the consumer groups CG2 and CG3 prefer a specific power producer as a primary power producer. In this example the power consumers PC in the second consumer group CG2 have a consumer group characteristic requiring the third decentralized power DPP3 to be the preferred power producer for supplying energy to the consumer group CG2. Furthermore the second consumer group CG2 requires the first central power producer CPP1 to be the second most preferred or a back-up supplier. It should be noted that the central control arrangement CCA may also select a back-up supplier or alternative second most preferred supplier e.g. based on geographical locations.

Likewise, the second user group CG2 may also have a demand regarding the allowed maximum cost for the consumed energy. Hereby, the central control arrangement CCA may control one or more power consuming units/components at the power consumers PC in the second consumer group CG2, based on the cost of the power produced by the third decentralized power producer DPP3. Thereby facilitating that the power consumers in the second consumer group CG2 consumes the most power when the power produced by the third decentralized power producer DPP3 is cheapest. Alternatively if the cost of the power produced by the third decentralized power producer DPP3 raises e.g. above a predetermined level, the power consumers in the second cluster CG2 may then be controlled to consume less power, and/or may be adapted to consume power produced by the first central power producer CPP1.

The third cluster C3 may be established by the central control arrangement CCA based on the location in the utility grid UG of the consumer group CG3 in relation the location of the power producers CPP1 and DPP2 in the utility grid UG. Furthermore considerations of matching expected power consumption of the consumer group CG3 and the expected power produced by the power producers CPP1 and DPP2 is made, to reduce power transmission distance and hence reduce power losses in the utility grid UG.

Just like a power consumer PC may be a member of more than one consumer group CG (as illustrated the power consumers PC of consumer group CG6 are also members of consumer group CG4), one or more consumer groups CG and/or power producers PP may be members of one or more clusters C as illustrated with the clusters C4 and C5.

The cluster C4 illustrates that a cluster may comprise other clusters (the cluster C4 comprises the cluster C5a plurality of consumer groups (the cluster C4 comprises three consumer groups CG4, CG5, CG6), and a plurality of power producers (the cluster C4 comprises three power producers CPP2, DPP6 and DPP5).

As an example, the cluster C4 may be established based on prognoses so that the estimated power production of the power producers CPP2, DPP5, and DPP6 in cluster C4 substantially correspond to prognosis regarding the expected power consumed by the three consumer groups CG4, CG5 and CG6 within a predetermined time span.

Further, the fifth cluster C5 which comprises the sixth consumer group CG6 and the decentralized power producer DPP6 may be established based on a wish/demand regarding the amount of green energy consumed, e.g. 70/30 (green energy/brown energy). Therefore, the sixth consumer group CG6 is matched with the sixth decentralized power producer DPP6 (e.g. one or more wind turbines) and the central control arrangement CCA may then control power consuming units/components of the power consumers of the sixth consumer group CG6 to consume most energy when the power producer DPP6 produces most energy, thereby resulting in a larger amount of green energy in the utility grid near the consumer group CG6.

It is generally understood that the central control arrangement CCA may facilitate prioritizing between different tasks, power consumer parameters PCP, power producer parameters, prognoses and the like.

As an example, the central control arrangement CCA may have a first priority being that local expected power consumption matches a local expected power production within a predefined time span. Further, the central control arrangement CCA may have a second lower priority, being fulfilling consumer demands regarding power costs, and a third further lower priority being fulfilling consumer demands regarding consumed power type (i.e. green/brown power).

It is understood that the central control arrangement CCA in a preferred embodiment of the invention may have access to utility grid characteristics e.g. comprising information of the physical structure and/or behaviour of the utility grid UG. Such utility grid characteristics may e.g. comprise voltage levels at specific sections of the utility grid, shifting possibilities to alter power transmission paths in the utility grid UG, current and/or expected power transmitted at a specific section of the utility grid UG, impedances in transmission lines TL and distribution lines DL at specific sections of the utility grid UG, the amount of a power type in the grid UG at specific areas of the utility grid (e.g. amount of brown versus green energy) or the like.

These utility grid characteristics may be made available to the central control arrangement CCA and may e.g. be used to estimate preferred power transmission paths, e.g. to decrease the power loss in the utility grid UG due to the impedance if another power transmission path may be more advantageous, e.g. by having a lower impedance, so that even though the power will be transmitted over a larger distance than another possible shorter transmission path having a higher impedance, the power loss would be lower due to the lower impedance.

Likewise, the utility grid characteristics may be used to establish consumer groups CG and/or clusters C and adapt the produced power in the cluster(s) C to the consumed power (or vice versa), hereby assuring that excess power/overproduced power is not transmitted at areas of the utility grid UG which are not capable of transmitting larger amounts of power. This is advantageous since certain transmission lines TL and/or distribution lines DL (e.g. older transmission lines and/or distribution lines) in the utility grid UG may not always be capable of transporting the same amount of power as other transmission lines TL and/or distribution lines DL, and this problem has increased due to the increased connection of new power plants PP, especially decentralized power plants DPP and connection of new power consumers PC to the utility grid UG. By establishing clusters C of power consumers PC and power producers PP based on the structure of the utility grid UG, such problems may be avoided.

In an embodiment of the invention, the central control arrangement CCA may take into consideration the efficiency of the power producers dependent of the time, and adapt power produced, power consumed, power transmission path in the utility grid UG and the like based on the efficiency of the power producers PP.

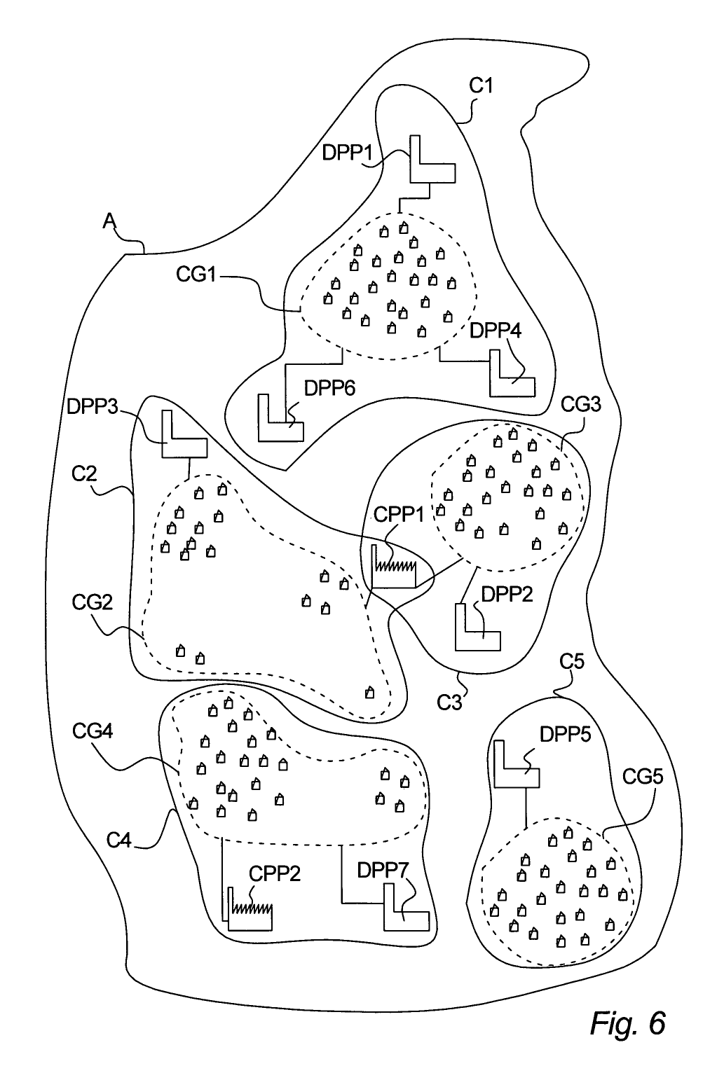

FIG. 6 illustrates an embodiment of the invention, wherein an area A comprises a number of clusters C1-C5 which are adapted so that the expected power consumption of the consumer group(s) CG of local power consumers PC in a cluster C within a predetermined time span is controlled by the central control arrangement CCA to substantially match the expected power produced by the power producers CPP and DPP in the same cluster C, within substantially the same time span.

In this embodiment it is preferred that the clusters C1-C5 are established based on the structure of the utility grid UG, so that the consumer groups CG1-CG5 are supplied with power produced by power producers located closest in the utility grid UG to the power consumers PC.

It is in FIG. 6 illustrated by solid lines between power producers CPP and DPP and consumer groups CG, which of the power producer DPP1-DPP7, CPP1, CPP2 is intended as main power supply to which of the consumer group CG1-CG5. For example, the power producers DPP1, DPP4 and DPP6 are intended to supply power to the consumer group CG1 in the cluster C1. The power producers DPP3 and CPP1 are intended to supply power to the consumer group CG2 of the cluster C2 and the power producers DPP2 and CPP1 are intended for supplying power to the consumer group CG3 of the cluster C3 and so on.

Hereby, the power transmitted between the clusters C1-C5 is significantly decreased, hence the power loss in the utility grid UG due to transmittal of over production of power in the utility grid UG may be significantly decreased. This is possible because the power is transmitted over shorter distances since the expected local power consumption matches the expected local power consumption (or vice versa) of a cluster.

It is understood that as with FIG. 5, even though the utility grid UG comprising substations SUB, distribution lines DL and transmission lines TL these are not illustrated in FIG. 6, each power producer PP and each power consumer PC in a consumer group CG is connected to the utility grid UG by means of substations SUB, distribution lines DL and/or transmission lines TL of the utility grid UG.

In an embodiment of the invention, the central control arrangement CCA facilitates adjustment of one or more power producers PP, to control the amount of reactive power and/or real power produced by the one or more power producers PP. This may be advantageous if the central control arrangement CCA registers an expected increased need of e.g. reactive power due to expected establishment of an inductive load, e.g. by starting up a motor or a transformer.

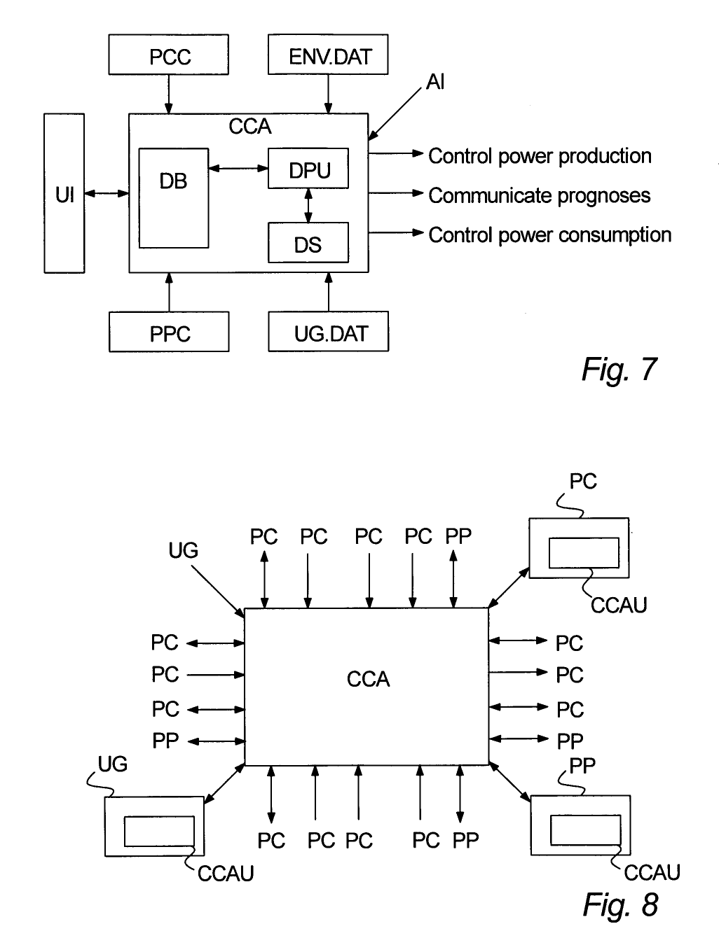

FIG. 7 illustrates the central control arrangement CCA according to an embodiment of the invention. As illustrated, the central control arrangement CCA may comprise one or more data processing units DPU for establishing and/or validating one or more prognoses, receiving and transmitting data, establishing consumer groups CG and/or clusters C, determining consumer group characteristics and the like.

The control arrangement CCA may in an embodiment comprise data storage means DS, e.g. comprising algorithms, sets of rules, methods, experiential data and the like which the data processing unit DPU may use to establishing and/or validating consumer groups CG, clusters C, prognoses and the like.

The central control arrangement CCA may likewise in an embodiment of the invention comprise one or more data bases DB, and/or servers.

The prognoses may, as mentioned, be established based on a plurality of gathered and/or stored data such as the power consumer characteristics PCC, power producer characteristics PPC, environmental data ENV.DAT comprising meteorological information such as weather forecasts, experiential data regarding meteorological conditions, tide information, information regarding time of year and the like, data regarding the utility grid UG.DAT, and/or the like. Furthermore the central control arrangement CCA may comprise additional input means AI for receiving various information's which are not falling within any of the mentioned categories.

In a preferred embodiment of the invention, the central control arrangement CCA may be accessed by means of one or more user interfaces UI, accessible by one or more users, and the users may by means of the user interface(s) UI monitor the central control arrangement CCA, the power consumers PC, the power producers PP, the utility grid UG, the user may initiate calculation of prognoses, retrieve status reports e.g. of balance between power consumption and power production and the like.

It is understood that even though it is preferred that prognoses, clusters C and/or consumer groups CG are established at least partly automatically by the central control arrangement CCA, a user may in an embodiment of the invention manually configure e.g. a cluster C made by the central control arrangement CCA and/or the user may create, initiate establishment and/or validations of consumer groups, prognosis CG and/or clusters C, which the central control arrangement CCA can not change.

In an embodiment of the invention, the central control arrangement CCA updates established prognoses, e.g. prognoses of the expected power consumption of a consumer group (CG), based on the time to when a power consumption and/or power production is expected. As an example, a prognosis regarding an expected power consumption within a e.g. twenty-four hour time span i.e. t=0 h to t=24 h, may be updated more often within t=0 h to t=2 h to achieve a more precise short-term prognosis since a short-term prognosis is often more precise than a long-term prognosis due to varying, altered and/or imprecise data. It is preferred that a prognosis is updated at least one time before the power consumption (or power production) is expected to take place.

FIG. 8 illustrates an embodiment of a central control arrangement CCA receiving individual power consumer characteristic PCC and individual power producer characteristic PPC from a plurality of power consumers PC and power producers PP. As illustrated by arrows, the central control arrangement CCA may facilitate a two way communication with the power producers PP and power consumers PC, to be able to control the power production of power producers PP, to communicate prognoses to power producers PP's or power consumers PC's, to control power consuming units at power consumers PC, and the like.

Further, as illustrated by the arrows, the central control arrangement CCA may facilitate a one-way communication with some power producers PP and/or power consumers PC, hereby only receiving power consumer characteristics PCC from power consumers PC and power producer characteristics PPC from power producers PP, without being able to control power consuming units at the power consumers PC, control power production at power producers PP or communicate prognoses to power producers PP. It should be noted that the central control arrangement CCA is also able to communicate with the utility grid UG e.g. by communicating with substations SUB of the utility grid UG.

Furthermore FIG. 8 illustrates an embodiment of the invention where the central control arrangement CCA communicates with central control arrangement units CCAU located at the power consumer PC, power producer PP and/or in the utility grid UG e.g. in relation to a substation SUB.

It should be noted that the communication between the central control arrangement CCA and the power producers PP and power consumers PC may include a feed-back, hence the central control arrangement CCA get a verification of e.g. increased or decreased power production or increased or decreased power consumption. This is advantageous e.g. when the central control arrangement CCA informs power consumers PC or power producers PP of e.g. an amount of power to be produced and/or an amount of power to be consumed, e.g. to achieve adaption of local power production and local power consumption. By receiving feed-back from power producers and/or consumers, the central control arrangement CCA can verify that the local power production and local power consumption matches or will be regulated to match.

As another example, in the situation where a storm causes a wind power park to produce a huge amount of power, the power consumption in the area near the wind power park may be not be large enough to consume all the power produced by the wind power park. This leaves the operator with the problem of an overproduction of power. The excess of power may then be transmitted via the utility grid UG to be consumed in other areas distant from the wind power park which will load or stress the utility grid UG. In some situations or in some parts of the utility grid UG this transmittal of excess power is no problem, but in some other parts of the utility grid UG where e.g. the infrastructure of the utility grid UG is poor, it may give rise to problems such as power losses.

In the latter situation it might be advantageous to also consume the excess of power in the local area of the wind power park. Such consumption of excess of power may be controlled by the central control arrangement CCA if the central control arrangement CCA has access to control power consuming units at one or more local power consumers PC. To be able to verify to the net operator that the excess power is consumed, feed-back is sent from the power consumer PC to the central control arrangement CCA when the consumption of the excess power has started.

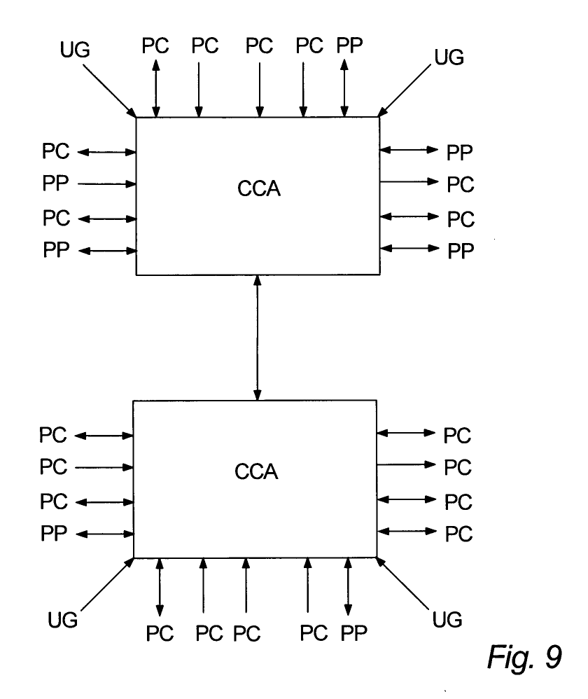

FIG. 9 illustrates an embodiment of the invention, wherein two central control arrangements CCA communicates to exchange information regarding prognoses, power consumers, the utility grid UG, power consumers PC, power producers PP, and the like. It is understood that even though only two central control arrangements CCA communicates in FIG. 9, more than two central control arrangements CCA may in an embodiment communicate to exchange information.

It will be understood that the invention is exemplified above and that the drawings comprising examples of embodiments, examples of clusters, examples of groups of power consumers, examples of power consumer characteristics, power producer characteristics, utility grid characteristics and the like, but it is understood that the invention is not limited to the particular examples above but may be designed in a multitude of varieties within the scope of the invention, as specified in the claims e.g. by combining the described embodiments.

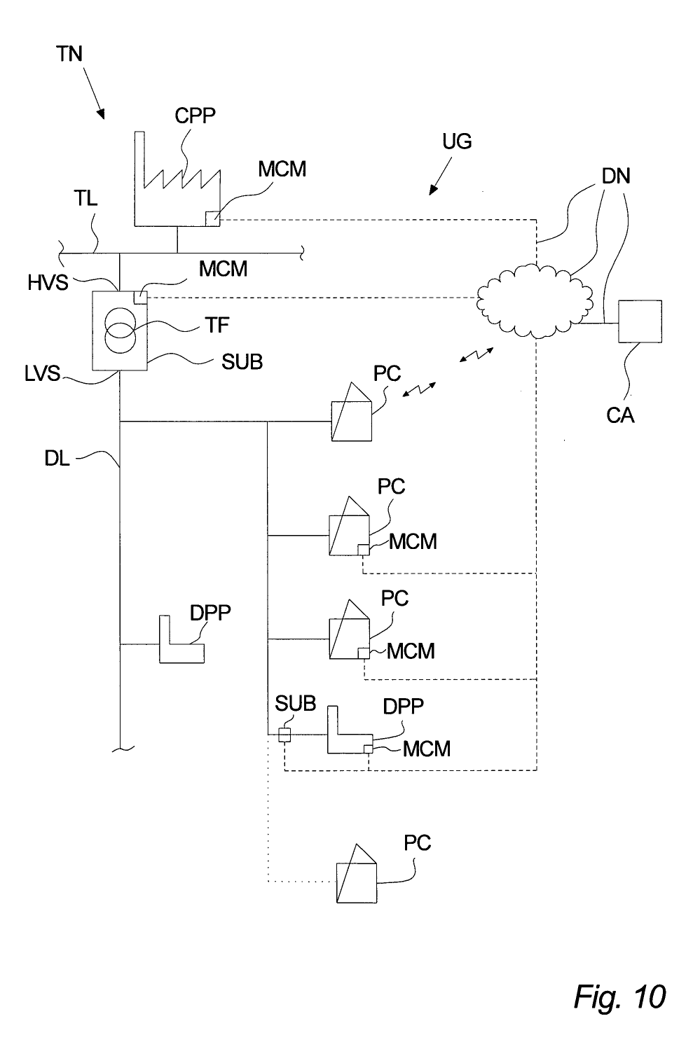

FIG. 10 illustrates part of a power transmission network TN according to an embodiment of the invention. It should be emphasized that FIG. 10 and the description hereto only illustrates a schematic presentation of a part of a power transmission network TN serving to ease understanding of the present embodiments of the invention. Hence a more correct presentation of a power transmission network TN would normally include more substations SUB, transmission lines TL, distribution lines DL, power consumers PC, etc than what is illustrated on FIG. 10.

The illustrated power transmission network TN comprises a central power producer CPP, a substation SUB in the form of a transformer TF having a high voltage side HVS and a low voltage side LVS, decentralize power producers DPP, power consumers PC, a data communication network DN, a control arrangement CA and a utility grid UG comprising transmission lines TL and distribution lines DL.

The central power producer CPP and the decentralized power producers DPP produce electric power. This electric power is transmitted to the power consumers

PC via the transmission lines TL, the distribution lines DL and the substations of the utility grid UG.

The power produced by the power producers CPP and DPP may not be directly applicable by the power consumers PC due to different voltage levels used during the transmission of power over longer distances. Typically the output at the power producers CPP and DPP needs to be transformed in the utility grid before it reaches the consumers.

Accordingly, the output voltage often needs to be transformed at least once before power can be consumed by the power consumers PC. The transformation of the voltage is made in the utility grid UG at substations SUB comprising transformers TF typically step-down transformers.

In FIG. 10, the control arrangement CA is illustrated as being connected to the central power producer CPP, one of the decentralize power producers DPP, the substation SUB/transformer TF and some of the power consumers PC via a data communication network DN.

At the central power producer CPP, the decentralized power producer DPP, the substation SUB/transformer TF, the power consumer PC and parts of the transmission lines, a measuring and communication module MCM may be located. The task for the measuring and communication module may be different depending on which element it is placed. Hence, at the transformer TF it may measure different parameters such as temperature at different locations of the transformer TF, voltage, current, power, etc. and communicate these measurements to the central control arrangement CCA. At the power consumer PC, the primary task is regulating the consumption parts of the power consumers PC, e.g. by turning electrical appliances on and off. At the power producers CPP and DPP the primary task is to increase and decrease the energy production.

The control arrangement CA may then perform a mutual control of the elements of the power transmission network TN which is connected to the control arrangement CA. Such mutual control makes it possible to adjust the power production to comply with power demands or the other way around to adjust the power consumption to the produced power.

One significant advantages of such mutual control is that it becomes possible to protect e.g. substations SUB such as transformers TF from overload. By keeping e.g. the power handled by the transformer(s), the temperature of the transformer TF or the like within rated parameters of the specific transformer TF, the lifetime of the transformer TF may be increased, and breakdown of a transformer due to e.g. overload may even be avoided/prevented. This is desirable since e.g. transformers TF are rather expensive components of the utility grid UG and a breakdown of a transformer may result in power blackout in the grid, leaving power consumers without electric power.

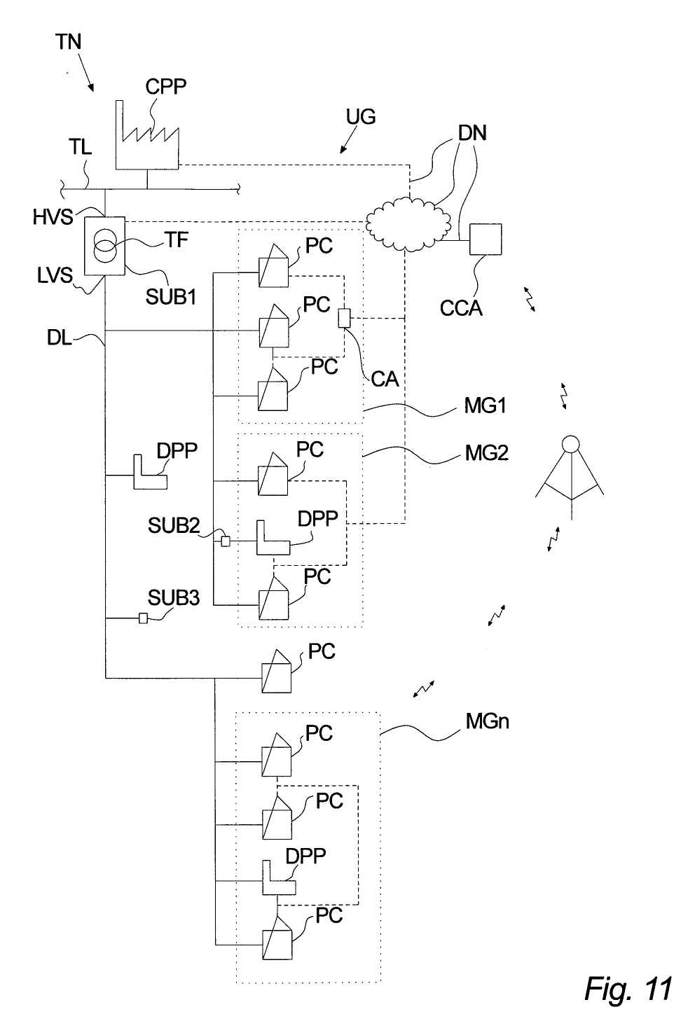

FIG. 11 illustrates as FIG. 10 part of a power transmission network TN. In FIG. 11 the power consumers PC and the decentralized power producers DPP are grouped in so called micro grids MG1-MGn.

The power consumers PC and decentralized power producers DPP may be grouped in micro grids MG1-MGn based on geographical location, power consumption/power production, location in the utility grid UG, etc.

As illustrated it is not necessarily all elements of power transmission network TN which is included in a micro grid MG

A micro grid according to an embodiment of the present invention may be controlled by means of control arrangement such as a central control arrangement CCA which may control the power consumption of power consumers PC and/or power production of power producers DPP, CPP, preferably based on established parameters of one or more specific transformers TF

In a further embodiment, one or more of the illustrated micro grids MG1-MGn may be equipped with a control arrangement CA which may be connected to power consumers PC and decentralized power producers DPP of a micro grid. In FIG. 11, the micro grid MG1 is illustrated with such a control arrangement CA. Thereby, it is possible for the control arrangement CA to control the consumption/production of that micro grid.

The control arrangement CA of micro grids MG1-MGn may furthermore as illustrated communicate with a central control arrangement CCA via a data communication network DN. The central control arrangement CCA may also communicate with central power producers CPP and transformers TF.

Thus, it becomes possible for the central control arrangement CCA to at least partly control the power consumption and/or the power production within the power transmission network TN. This enables the central control arrangement CCA to protect elements of the power transmission network TN such as the transformer TF.

The protection can be made by communicating e.g. to the central power producer CPP to increase or decrease the power production depending on the consumption in the utility grid UG or communicate to one or more of the micro grids MG1-MGn to increase or decrease power consumption, and for micro grids comprising decentralized power producers DPP to increase or decrease power production.

In this way the central control arrangement CCA can be set to balance the power transmission network TN and thus make sure that e.g. the transformer TF is not overloaded or in other ways loaded in an unwanted manner.

In relation to the data communication network DN illustrated in FIGS. 10 and 11 it should be noted that a part of the data communication network may be a public data communication network such as e.g. the interne.

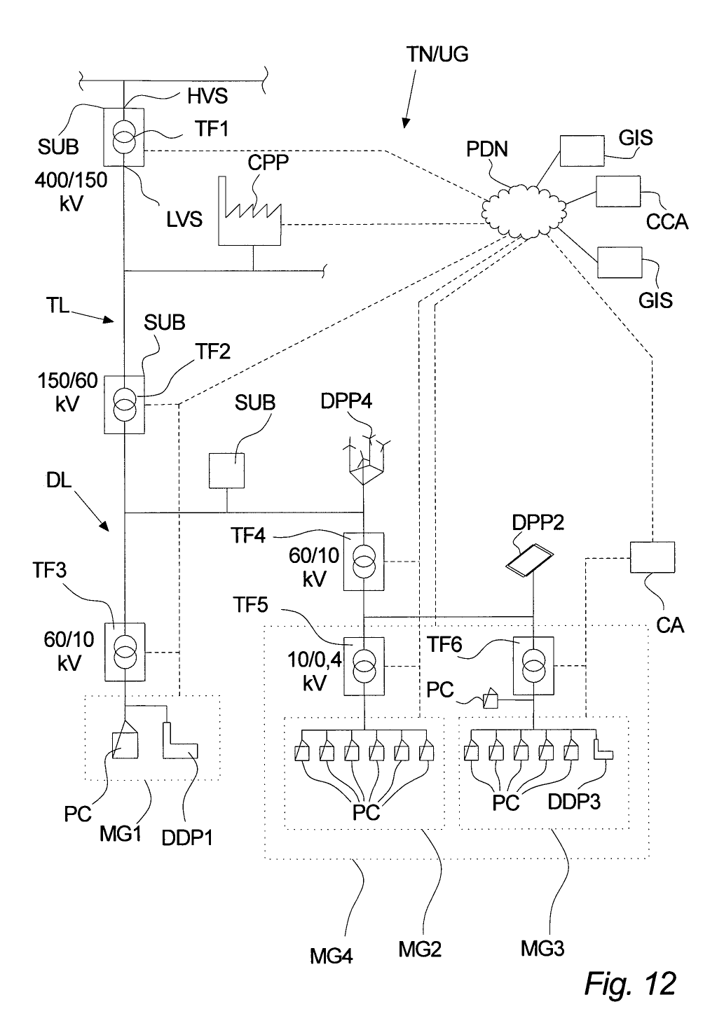

FIG. 12 illustrates a larger part of a power transmission network TN than what is illustrated in FIGS. 10 and 11. Hence, FIG. 12 illustrates how the power consumption may be balanced between a plurality of transformers TF1-TF6 and a plurality of micro grids MG1-MG4 according to an embodiment of the invention.

To be able to balance the power production/consumption an example of an important piece of information is the size or capacity of the transformers TF in the sub-grid/part of the utility grid UG which is intended to be balanced. Thus, it is advantageous to establish a reference value based on at least one parameter reflecting the state of said transformer TF.

With this information and information of the consumption in the sub-grid e.g. a micro grid MG on the lower voltage side LVS of the transformer TF, it is possible to determine the remaining transformer capacity. In case that the power consumption in the micro grid MG located on the lower voltage side LVS of the transformer TF is getting close to what the transformer TF is capable of handling it may be possible to decrease to the power consumption in the micro grid MG.

Now turning back to FIG. 12 such balancing of parts of the utility grid UG is e.g. illustrated by transformer TF6 and micro grid MG3. A local control arrangement CA is connected to both transformer TF6 and micro grid MG3 and furthermore e.g. via the public data communication network PDN to one or more grid information sources GIS. The grid information sources GIS may provide information of the price of energy, metrological information, grid control strategy, information of the structure and/or present behaviour of at least a part of the grid, and in general all other information which may be relevant for the central control arrangement CCA to be able to perform an optimal control of the utility grid UG and especially an optimal control of the micro grids MG.

From transformer TF6, the control arrangement CA may continuously be provided with information of parameters reflecting the state of the transformer TF6. Such parameters may e.g. be coil, air or oil temperature, power, voltage and current on the high and low voltage side HVS/LVS, time the transformer is allowed to be loaded above the rated power of the transformer, etc.

From micro grid MG3 the control arrangement CA may continuously be provided with information of power consumption from power consumers PC and power production from decentralized power producer DPP3. Further the control arrangement CA is initially provided with information of how much of the power consumption of the individual power consumers PC is at the control arrangements CA disposal. Typically it may be heating or cooling equipment, fans, light, etc. the control arrangement CA is allowed to control if necessary. It should be mentioned that the power consumption at the control arrangements CA disposal may be changed and may vary over time.

It is of cause understood that the said local control arrangement CA may also be spared so that the central control arrangement CCA facilitates control of the power consumers and/or decentralized power producers that may be a part of the micro grid, so as to comply with one or more established reference values of the transformer.

In a first scenario, if information is received by the control arrangement CA that a critical level of power is consumed in micro grid MG3 relative to the size/performance of the transformer TF6, the control arrangement CA (or the central control arrangement CCA if the control arrangement is spared) may decrease the consumption of power at the power consumers PC in micro grid MG3. In this way the transformer TF6 is protected from overload and the lifetime for the transformer TF6 may be increased.

Alternatively, since micro grid MG3 comprises a decentralized power producer DPP3 e.g. one or more wind turbines, solar cells, a generator driven by fossil fuel or the like, the control arrangement CA (or CCA) may increase the power produced by this/these decentralized power producer DPP3.

In a second scenario, if the decentralized power producer DPP3 is a wind power plant producing more power than the power consumers PC in micro grid MG3 are consuming, the excess power may be “pushed” back through transformer TF6 and out in the remaining utility grid UG.

Depending on the structure of the utility grid UG in the area around micro grid MG3 this might be a problem to the stability of the utility grid UG. This is especially the case if in a geographical area the utility grid is provided with power from a plurality of wind power plants. Hence, if the wind velocity increases above e.g. 25 m/s all of the wind turbines will most likely close down within a short period of time. Since the power consumers in the same area do not stop consuming power just because of high wind velocity the stability of the utility grid is especially tested in such situation.

Now returning to the second scenario, for the managers of the distribution of power in the utility grid UG it may be advantageous to establish a threshold defining a critical allowable amount of excess power “pushed” back through a transformer. In such situation it is advantageous to be able to regulate the consumption/production of power at the low voltage side LVS e.g. in micro grid MG3 so as to avoid that the threshold is exceeded. Such regulation serves to protect the transformer TF6 In the same way as described in relation the above mentioned first and second scenario, transformer TF3 and micro grid MG1 may balanced and in the same way as the first scenario transformer TF5 and micro grid MG2 are balanced.

It should be mentioned that the balancing may be controlled by a local control arrangement CA as described above but also from a central control arrangement CCA.

The central control arrangement CCA may be capable of including e.g. a central power producer CPP in the balancing of the utility grid UG. Furthermore the central control arrangement CCA may control e.g. two micro grids such as MG2 and MG3 or even more micro grids. In this way the consumption in the sub-grid on the low voltage side LVS of transformer TF4 may be balanced with the capacity of transformer TF4.

In the same way, all four illustrated micro grids MG1-MG4 may be utilized to balance the consumption with the capacity of transformers TF1 and/or TF2.

It should be noted that allowing the managers of the distribution of power in the utility grid to control consumption at the power consumers PC, the power consumers PC may receive an amount of money, discount on the price of one kWh, etc.

The power consumers PC may on a voluntary basis provide to the manager of the utility grid UG more or less components such as machines, heating or cooling equipment, pumps, etc. for the manager to control if needed. In return, the more potential power and the higher degree of flexibility in consuming the potential power, the more the power consumer PC may gain from the grid manager.

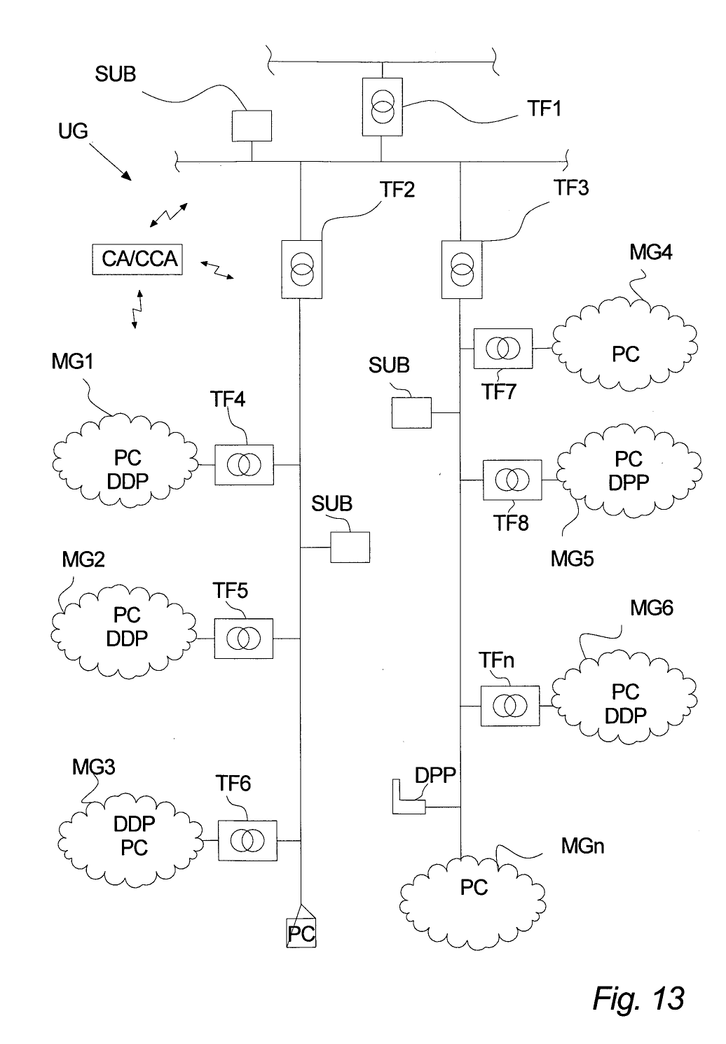

FIG. 13 illustrates part of a utility grid UG comprising a plurality of micro grids MG1-MGn, a plurality of transformers TF1-TFn, substations SUB and a control arrangement CA according to an embodiment of the invention. The bidirectional data communication between the micro grids MG1-MGn, transformers TF1-TFn and the control arrangement CA is illustrated as wireless data communication. It is not essential on which technology the data communication is based, hence both different kinds of wireless and wired technologies may be used and the skilled person would choose the appropriate technology according to the utility grid UG.

In the illustrated part of the utility grid UG the load i.e. the amount of power/current drawn from the transformer TF1 is controlled by the control arrangement CA. The control arrangement (which may be central control arrangement CCA and/or a control arrangement CA arranged locally) controls the load of transformer TF1 by regulating the power consumption/power production in micro grids MG1-MGn. Hence if a problem occurs in transformer TF1 signals may be transmitted to one or more the micro grids MG1-MGn that a problem has occurred and that action needs to be taken to avoid or minimize the damages such a problem may cause at transformer TF1. Actions may e.g. be regulating the power consumption or regulating the power production in the individual micro grids MG1-MGn according to the problem.

Within a micro grid a components may communicate that a problem is likely to occur if no action is taken. If e.g. a decentralized power producer driven by fossil fuel is running out of fuel the power consumption within that micro grid may be reduces to save fuel. Alternatively another decentralized power producer within the micro grid may be asked to start or increase power production. If the problem can not be solved within the micro grid other micro grids, central/decentralize power producers or power consumers may be asked for backup.

Because of the fact that it is possible for the control arrangement CA to control the power consumption at consumer level i.e. control the individual components such as machines, heaters, coolers, etc. at the individual power consumers PC and the decentralized power producers DPP it is possible for the control arrangement CA to control the load of all of the transformers TF1-TFn.

It should be noted that the micro grids MG1-MGn does not necessarily include all power consumers PC and all decentralized power producers DPP in the illustrated area. Furthermore it should be noted that the micro grids MG1-MGn may include a plurality of power consumers PC and/or decentralized power producers DPP even though only one of each is illustrated.

As described above, the control arrangement regulates based on a principle of protecting transformers TF of the utility grid UG. It should be mentioned that also the capacity of the transmission/distribution lines of the utility grid UG may be utilized protected by the control arrangement CA. Based on information from e.g. a transformer TF or another substation SUB measuring e.g. the current, load, type of load, temperature or the like in the transmission/distribution lines indicating a potential problem on which a control arrangement of an embodiment of the present invention may react. Such problem could e.g. be overload of a conductor e.g. in form of to high current conducted by the conductor. To remedy such overload, the control arrangement CA may communicate to one or more of the micro grids MG1-MGn to reduce power consumption or to increase local power production. It should be noted that also power consumers PC and decentralized power producers DPP not part of a micro grid MG1-MGn may be utilized to regulate by the central arrangement CA.

When a part of a utility grid is controlled as described above i.e. from a control arrangement controlling consumption/production of power locally in the utility grid e.g. by controlling a micro grid, this part of the utility grid might sometimes be referred to as smart grid. Hence according to an embodiment of the present invention a transformer in a smart grid is protected e.g. from overload.

A generalized threshold above which a transformer TF or transmission/distribution line TL/DL is said to be overloaded may be difficult to define or may not be advantageous to define in that the performance of components in the grid may not be utilized in an optimal manner. Individual thresholds for individual components i.e. e.g. for transformers TF and transmission/distribution lines TL/DL may however be defined by the manager of the utility grid. Hence, in one part of the utility grid UG managed by a first manager, the threshold for overload of components may be different from another part of the utility grid UG controlled by a second manager. Most utility grid managers do agree that if about 90% of the capacity of a transformer TF and/or of the transmission/distribution lines TL/DL has been reached it is time to take action to protect the components of the utility grid UG.

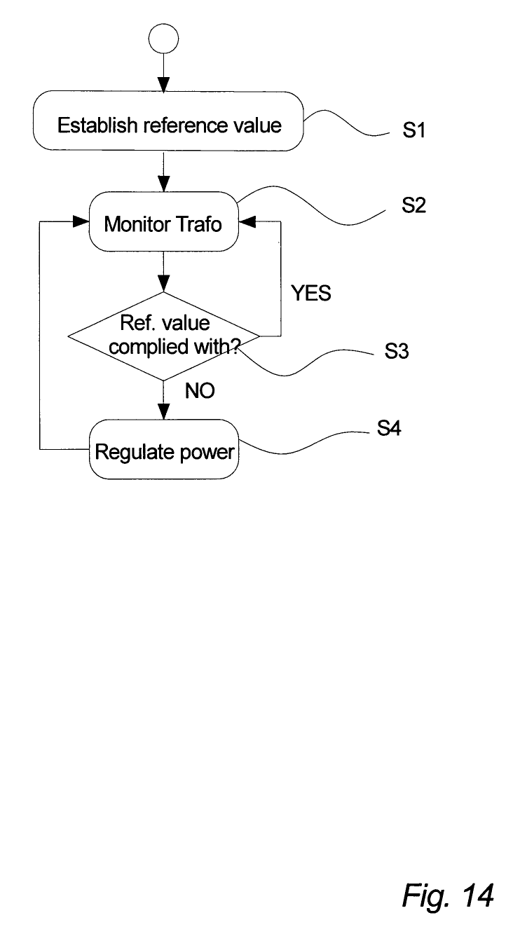

FIG. 14 illustrates a flow chart of one aspect of the invention. In the first step S1 reference values of one or more parameters of at least one transformer is established. In the second step S2 the one or more parameters of the at least one transformer is monitored. In the third step S3 the established reference values and the monitored parameters are compared/correlated; hence if the comparison is accepted return to step S2 is performed and if the comparison is not accepted continue to step S4. In step S4 the power consumption/production is regulated in the micro grid on the low voltage side of the monitored transformer.

At least a part of the establishment of reference values in step S1 may be part of an initial process which takes place before management so as to balance the transmission of power in the power transmission network TN is performed. When one or more parameters on which it is desired to monitor the transformer is determined, one or more reference values is established. A reference value should be chosen to ensure that no damage is caused to the transformer in operation. Typically, the maximum value and/or preferred operational values can be found among the technical data of the transformer and thereby the reference values may be deduces from a book of technical data of the transformer. Also or alternatively, the reference values may be chosen based on experiential data or simply by a decision based on no particular reason.

Relevant parameters for which a reference value may e.g. be temperature ranges, power ranges, voltage ranges, current ranges, indication of direction of power, the power flow through the transformer, fluid level etc.

In step S2 the parameters chosen in step S1 are monitored. Typically this monitoring does not go beyond normal surveillance of a transformer in operation, hence most parameters may be easy to monitor without additional data acquisition equipment. When the parameters are measured their actual value are communicated to a control arrangement CA and/or to a central control arrangement CCA typically not located in relation to the transformer.

In step S3 the actual values of the monitored parameters are compared to the established reference values of the individual parameters. If everything is as it should be no action is required and the monitoring and data acquisition of the chosen parameters of the transformer continues as described in step S2. If a reference value is not complied with action needs to be taken in step S4.

Depending on how a reference value is not complied with and depending on the micro grid on the low voltage side of the transformer different actions needs to be taken.

In step S4 such actions are effectuated and the following describes some examples of reference values not complied with and actions taken to comply with the reference value again.

One parameter which may be monitored is the direction of the power flow through the transformer TF. In a step-down transformer a reference value of this parameter may be set to allow a predefined amount of amps in a direction from the micro grid to the rest of the utility grid. This reference value may e.g. be exceeded if a wind power plant produces a great deal of power on the low voltage side of the transformer. Reduced the power flow and again comply with the reference value the control arrangement may initiate power consumption at the power consumers.

Another parameter which may be monitored is the power drawn from the low voltage side LVS of the transformer TF. From the technical data delivered from the manufacture of transformer TF a nominal power may be found and used as a reference value for this parameter. This reference value may e.g. be exceeded in situations where a plurality of heating equipment is in use in a micro grid MG. To be able to comply with the exceeded reference value for the power drawn from the low voltage side LVS of the transformer TF the control arrangement CA may turn off some of the power consuming devices in the micro grid MG or if possible initiate an increased production of power in a decentralized power plant DPP within the micro grid MG. Also a central power producer may in an embodiment of the invention be controlled.

Yet another parameter which may be monitored is the temperature e.g. in the coil, in cooling oil, in the air around the coil, etc. Typically a reference value relating to these temperatures is derivable form technical data of the transformer TF. If such reference value is exceeded it may indicate that the transformer is overloaded or close to overloaded. A reaction hereto is to reduce the load of the transformer e.g. by reducing power consumption at the lower voltage side LVS of the transformer or by increasing power production on the lower voltage side of the transformer.

Above only transformer parameters are mentioned but it should be emphasized that parameters acquired from other elements than the transformer TF or acquired from utility grid managers, control systems, etc could be used by the control arrangement CA to control a micro grid MG. An example of such parameter is the cost of one kWh hence if the cost is very low the control arrangement may initiate power consumption e.g. lower the temperature in a freezer more than usually or heating water more than usually. The other way around if the price is high the control arrangement CA postpone power consumption in the micro grid MG.

It should be mentioned that the monitoring of parameters may be performed during a predefined period of time or continuously day and night.

1. A method of managing transmission of power in a power transmission network by means of a control arrangement, said power transmission network comprising:
a utility grid comprising transmission lines, distribution lines and one or more substations, one of said substations being a transformer having a high voltage side and a low voltage side, said transformer being adapted to transform power from a high voltage level to a low voltage level,
at least one central power producer being adapted to produce power, said power being transformed by said transformer from said high voltage level to said low voltage level,
a plurality of power consumers being adapted to consume said power produced by said at least one central power producer when said power is transformed by said transformer,
a data communication network connected to said one or more substations, said at least one central power producer, said plurality of power consumers and said control arrangement,
said method comprising the steps of:
establishing utility grid characteristic comprising at least one reference value based on at least one parameter reflecting the state of said transformer,
continuously monitoring said at least one parameter reflecting the state of said transformer, and
continuously controlling power consumption and/or power production at said low voltage side of said transformer based on said monitoring of said at least one parameter reflecting the state of said transformer,
said controlling of said power consumption and/or said power production comprising regulating said power consumption of one or more of said plurality of power consumers and/or regulating power production of one or more power producers located at said low voltage side of said transformer, so as to comply with said established reference value.

2. The method according to claim 1, wherein said plurality of power consumers and said one or more decentralized power producers located at said lower voltage side of said transformer are arranged locally in said utility grid so as to form a micro grid facilitating local adjustment of the consumed power and/or power produced locally in the micro grid.

3. The method according to claim 1, wherein said control arrangement is a central control arrangement.

4. The method according to claim 3, wherein said central control arrangement individually controls the power at a lower voltage side of a plurality of transformers (TF).

5. (canceled)

6. The method according to claim 1, further comprising the step of establishing at least one consumer group by matching individual power consumer characteristics providing information of said power consumers,
said consumer group comprising one or more of said power consumers consuming of power transformed by said transformer.

7. The method according to claim 1, wherein at least one of said at least one decentralized power producer is a mobile power producer.

8. The method according to claim 7, wherein said mobile power producer comprises a positioning determining arrangement being adapted to determining the geographical location of said mobile power producer, and
wherein said method comprises the step of detecting the geographical location of said mobile power producer by means of said positioning determining arrangement so as to determine the presence of said position mobile power producer in said power transmission network and/or the location of said mobile power producer in said power transmission network.

9. The method according to claim 1, wherein said reference value is determined based on a rated parameter for said transformer.

10. The method according to claim 1, wherein said at least one reference value is selected from a group of electric parameters, said group comprising:
the rated real power of said transformer,
the rated reactive power of said transformer,
the rated apparent power of said transformer,
the rated current of said transformer, or
the rated voltage of said transformer.

11-12. (canceled)

13. The method according to claim 1, wherein said at least one reference value relates to the direction of the power flow in said transformer.

14-15. (canceled)

16. The method according to claim 1, wherein said control of the power at said lower voltage side of said transformer comprises controlling of at least one power consumer at said lower voltage side and/or at least one decentralized power producer (DPP) at said lower voltage side (LVS) so as to prevent power from flowing from said lower voltage side (LVS) to said higher voltages side (HVS) of said transformer (TF).

17. The method according to claim 16, wherein said controlling of the direction of power flow further comprises the step of controlling the power production of one or more of said centralized power producers.

18. The method according to claim 1, wherein said monitoring of said parameter reflecting the state of said transformer comprises monitoring the power factor at said transformer.

19. The method according to claim 1, wherein said monitoring of said parameter reflecting the state of said transformer comprises monitoring the voltage transformed by said transformer.

20-21. (canceled)

22. The method according to claim 1 wherein said monitoring comprises monitoring the temperature of said transformer.

23. (canceled)

24. A micro grid comprising a plurality of power consumers and at least one decentralized power producer being adapted for production of power to one of more of said plurality of power consumers,
wherein said micro grid is located at the lower voltage side of a transformer said transformer being adapted for transforming power from a higher voltage level to a lower voltage level, and
wherein said micro grid is further configured so that said plurality of power consumers of said micro grid may further consume power from a central power producer of a utility grid, said utility grid comprising transmission lines and distribution lines, where said micro grid is connected to said utility grid by means of said transformer,
wherein one or more of said plurality of power consumers and/or at least one of said at least one decentralized power producer of said micro grid are controllable by means of a control arrangement,
said control being based on utility grid characteristic comprising at least one reference value being based on at least one parameter reflecting the state of said transformer, and a monitoring continuously of said at least one parameter reflecting the state of said transformer, so as to comply with said established reference value.

25. (canceled)

26. The micro grid according to claim 24, being controlled in accordance with a method according to any of the claims 1-19.

27. A utility grid comprising a plurality of micro grids according to claim 24.

28. (canceled)

29. The method according to claim 1, wherein said monitoring of said parameter reflecting the state of said transformer comprises monitoring the power transformed by the transformer.
